(19) United States
(12) Patent Application Publication
(10) Pub. No.: US 2024/0372621 A1
(43) Pub. Date: Nov. 7, 2024

(54) Management of Memory Access by Processors through High Bandwidth Interconnects to Memory Sub-Systems

(71) Applicant: Micron Technology, Inc., Boise, ID (US)

(72) Inventors: Saideep Tiku, Folsom, CA (US); Febin Sunny, Folsom, CA (US); Poorna Kale, Folsom, CA (US)

(21) Appl. No.: 18/651,534

(22) Filed: Apr. 30, 2024

Related U.S. Application Data
(60) Provisional application No. 63/499,927, filed on May 3, 2023.

(51) Int. Cl. H04B 10/25; G02B 6/12

(52) U.S. Cl. CPC H04B 10/25; G02B 6/12009; G02B 2006/12145

(57) ABSTRACT

A computing system having a photonic interconnect system configured between a plurality of memory sub-systems and a plurality of processing elements. The photonic interconnect system includes a plurality of first optical interface modules connected to the plurality of processing elements respectively; a plurality of second optical interface modules connected to the plurality of memory sub-systems respectively; and a photonic switch configured between the plurality of first optical interface modules and the plurality of second optical interface modules. The photonic interconnect system can dynamically allocate virtual communication channels, implemented via optical signals of different wavelengths in the photonic interconnect system, between the plurality of processing elements and the plurality of memory sub-systems.

### RELATED APPLICATIONS

The present application claims priority to Prov. U.S. Pat. App. Ser. No. 63/499,927 filed May 3, 2023, the entire disclosures of which application are hereby incorporated herein by reference.

### TECHNICAL FIELD

At least some embodiments disclosed herein relate to memory access in general and more particularly, but not limited to, memory access via optical connections.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a system configured with systolic memory access according to one embodiment.

FIG. 2 shows a memory sub-system configured to facilitate systolic memory access according to one embodiment.

FIG. 3 shows a processor sub-system configured to facilitate systolic memory access according to one embodiment.

FIG. 4 shows an optical interface circuit operable in a system of systolic memory access according to one embodiment.

FIG. 5 shows an optical interface module according to one embodiment.

FIG. 6 shows a configuration to connect a memory sub-system and a processor sub-system according to one embodiment.

FIG. 7 shows a configuration to connect memory sub-systems and a processor sub-system for systolic memory access according to one embodiment.

FIG. 8 and FIG. 9 show techniques to connect a logic die to a printed circuit board and an optical fiber according to one embodiment.

FIG. 10 shows a technique to use a compiler to configure the operations of systolic memory access according to one embodiment.

FIG. 11 shows a processor sub-system having processing elements configured to access memories allocated from a plurality of memory sub-systems according to one embodiment.

FIG. 12 shows the mapping between a virtual memory space addressed by a processing element and portions of memories allocated from a plurality of memory sub-systems according to one embodiment.

FIG. 13, FIG. 14, and FIG. 15 illustrate examples of photonic channels configured to manage memory accesses by processing elements according to one embodiment.

FIG. 16 and FIG. 17 show methods of memory access management according to some embodiments.

### DETAILED DESCRIPTION

At least some embodiments disclosed herein provide techniques for high bandwidth memories to provide memory services to multiple host systems in processing workloads with high performance (e.g., in training of a large models of artificial neural networks).

For example, deep learning training is a resource intensive process which is typically performed in environments such as server farms. The training process for large models are especially taxing on processing and memory resources, with a marked increase in memory utilization as the weight parameters, the gradients and updates are temporarily stored during a single training epoch. The memory consumption of the application can increase throughout the epoch and can be minimal at the start of the next epoch.

An elastic high bandwidth memory (HBM) can be used to feed data to, and accept data from, host systems configured to perform a large-scale deep learning training. In a computing system having such a high bandwidth memory (HBM), a processing cluster that is in charge of a specific application can be gradually granted access to an increased portion of the high bandwidth memory (HBM) as the epoch continues. The high bandwidth memory (HBM) can service multiple processing clusters running concurrently at different stages of their applications.

To avoid massive displacement of data, from other processing clusters, as a particular application grows in memory demand and consumes more memory, memory access to portions of the high bandwidth memory can be managed through selective allocations of different subsets of memory banks to different processing clusters. For example, a batch of banks per chip per rank can be assigned to a particular processing cluster. The allocation scheme can change in response to the change of the memory needs of the processing clusters.

A photonic interconnect can be configured to dynamically connect a processing cluster to a batch of memory banks assigned or allocated to the processing cluster. The photonic interconnect can facilitate high speed data transfer, with minimal energy consumption. Photonic communication channels of different wavelengths can be selected and configured, through a photonic switch, between the processing clusters and memory portions being accessed by the processing clusters. For example, the photonic switch can be implemented via arrayed waveguide grating (AWG) based photonic multiplexers.

For example, a multi-port input-output arrayed waveguide grating (AWG) configuration can have the capability to passively route information using the waveguide routing. As an example, four (4) wavelengths can be assigned to four (4) processing clusters respectively. The number of wavelengths used can be adjusted as per the bandwidth requirement. A processing cluster having assigned more wavelengths has more bandwidth in accessing the high bandwidth memory; and vice versa. Different ways to assign the wavelengths to the processing clusters can be used in different ways to access portions of memory banks of the high bandwidth memory.

Optionally, arrayed waveguide grating (AWG) based photonic switching can be used to passively address the memory banks/sections in the high bandwidth memory assigned to respective processing clusters. For example, transmissions of optical signals of a particular wavelength can be used for a particular processing cluster in addressing memory access; and the optical signals can be routed via the photonic switch to a particular memory controller having a section of memory being assigned to the particular processing cluster. Thus, the memory access is mapped to the section of memory controlled by the particular memory controller, instead of other respective sections controlled by other memory controllers. For example, virtual memory addressing can be used to implement the address space resolution and lump together the address ranges across memory controllers of different memory chips for a specific processing cluster connected to an optical interface circuit.

The photonic switch can be configured for balanced access to memory sub-systems by multiple processing elements. For example, a photonic switch can be connected between an array of processing elements and an array of memory sub-systems. Lights of different wavelengths can be transmitted through the photonic switch in parallel for concurrent accesses. A same address identified by a processing element C1 can be in any of the memory sub-systems (e.g., M1, M2, . . . , M4). The computing system can automatically map the address to one of the memory sub-systems based on the range memory region contains the address. The optical interconnect system can implicitly identify the memory sub-system being addressed using the wavelengths of optical signals used to transmit the memory access request. Optionally, the system can virtualize the memory space being accessed by each processing element into slices of memory distributed across the memory sub-systems (e.g., M1, M2, . . . , M4).

Optionally, a large number of dynamic random access memory (DRAM) chips can be configured in a memory sub-system for systolic memory access where data is configured to flow between two memory sub-systems through a processor sub-system in directions predetermined for clock cycles. The processor sub-system is configured to operate on the data flowing between the memory sub-systems.

Due to the increasing demands from modern processing units and applications, orchestrating data movement to and from processing elements and memory has become an important consideration to be made in system design. To address the above and other challenges and deficiencies, systolic memory access assisted by high-bandwidth, wavelength division multiplexing (WDM) based photonic bandwidths can be used. High bandwidth photonic interconnects are be configured to connect disaggregated memory and compute banks.

The systolic memory access pattern can efficiently utilize the high bandwidth offered by wavelength division multiplexing (WDM) based photonic interconnects, with minimal buffering and associated latency. The systolic flow of access and hence data also facilitates lower hardware cost. Photonic links do not support duplex communication over a same waveguide/optical fiber. A typical usual solution is to double the number of optical fibers/waveguides to facilitate duplex communications over separate waveguides/optical fibers. The systolic memory access pattern avoids such a communication pattern.

In one embodiment, two photonic interconnect-enabled memory banks are separately connected to a single bank of high performance computing elements. For example, each of the memory banks can be configured with an optical interface circuit (OIC) that provides a port for a connection to a ribbon of one or more optical fibers. The bank of computing elements can have two optical interface circuits for connections with the memory banks respectively with ribbons of optical fibers. Data is configured to flow from one memory bank toward another memory bank, through the computing element bank in one cycle; and data is configured to flow in the opposite direct in another cycle.

Such data flow techniques can be well suited for certain applications that have predictable and systematic read/write patterns. Examples of such applications include deep learning inference based on very large models (e.g., bidirectional encoder representations from transformers (BERT) with large models).

For example, a memory sub-system to implement systolic memory access can have a plurality of high bandwidth memory (HBM) devices. Each HBM device has a set of random access memories (e.g., dynamic random access memory (DRAM) chips) managed by a single memory controller. The memory controllers of the HBM devices of the memory sub-system are connected via electrical interconnects to a central optical interface circuit that can transmit or receive data over an optical fiber ribbon.

For example, the bank of processing elements can have a collection of interconnected server-scale processors. The processors can be tasked with various parts of the inference task graph, and can pass results of computation operations from one processor to next. A free processor in the bank can be fed the next set of data buffered in the optical interface circuits (e.g., next set of the data in the same batch) as soon as it is done with its assigned processing of task graphs.

For example, an optical interface circuit can be an electro-optical circuit, which includes buffering circuits and the optical transmission and reception circuits. For example, microring resonators controlled by tuning circuits can be used in transmission circuits to modulate optical signals in a waveguide to transmit data; and optical signals in microring resonators coupled to a waveguide can be measured via photodetectors in reception circuits to identify received data.

The systolic data movement allows for quick data movement from a memory bank to a processing element bank and to another memory bank. To facilitate the systolic data movement, the data involved in the operations are defined and organized for easy access via a static memory mapping scheme that can be determined through address assignments at a compiler level.

For example, the compiler can be provided with an internal mapping of the systolic memory access system along with a transaction level model (TLM) of system. Based on the transaction level model the compiler can be configured to identify the read and write latency tolerances and decide how to map and extract data for a given application using systolic data movements.

For example, a typical inference acceleration application has a predictable data footprint, which allows the compiler to determine a valid static data mapping and a read and write schedule for accessing the high bandwidth memory devices.

To map data placements, the compiler can utilize a memory virtualizer and consider the memory array as a contiguous memory space in assisting the generation of physical addresses needed across multiple high bandwidth memory (HBM) chips.

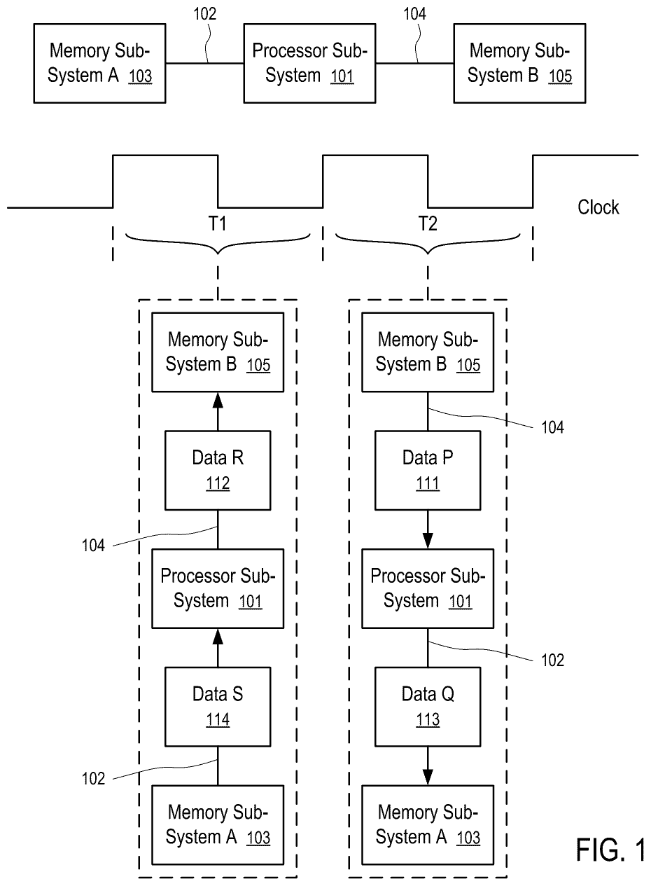

FIG. 1 shows a system configured with systolic memory access according to one embodiment.

In FIG. 1, two separate connections 102 and 104 are provided from a processor sub-system 101 to two separate memory sub-systems 103 and 105 respectively. In some predetermined or selected clock cycles (e.g., odd cycles, such as clock cycle T1), the communications over the connections 102 and 104 are configured in one direction; and in other clock cycles (e.g., even cycles, such as clock cycle T2), the communications are configured in the opposite direction. Preferably, the connections 102 and 104 are optical (e.g., via ribbons of optical fibers that are configured separate from a printed circuit board).

For example, at clock cycle T1, the connection 102 is configured to communicate data 114, retrieved from the memory sub-system 103, in the direction of from the memory sub-system 103 to the processor sub-system 101; and the connection 104 is configured to communicate data 112, to be written into the memory sub-system 105, in the direction of from the processor sub-system 101 to the memory sub-system 105. In contrast, at clock cycle T2, the connection 104 is configured to communicate data 111, retrieved from the memory sub-system 105, in the direction of from the memory sub-system 105 to the processor sub-system 101; and the connection 102 is configured to communicate data 113, to be written into the memory sub-system 103, in the direction of from the processor sub-system 101 to the memory sub-system 103.

Since the communications over a connection (e.g., 102 or 104) are in a predetermined direction at each clock cycle (e.g., T1 or T2), the lack of bi-direction communication capability over an optical link is no longer a limiting factor in the use of a computing system that uses the technique of systolic memory access.

Optionally, the processor sub-system can have a pipeline of processing elements configured to propagate two pipelines of tasks in opposite directions, in sync with the communication directions of the connections 102 and 104.

For example, input data 111 can be retrieved from the memory sub-system 105 and processed via a pipeline in the processor sub-system 101 for a number of clock cycles to generate output data that is written into the memory sub-system 103. Similarly, input data 114 can be retrieved from the memory sub-system 103 and processed via a pipeline in the processor sub-system 101 for a number of clock cycles to generate output data that is written into the memory sub-system 105.

Optionally, the propagation of data within the processor sub-system 101 can change directions. For example, the output data generated from processing the input data 111 retrieved from the memory sub-system 105 can be written back to the memory sub-system 105 after a number of clock cycles of pipeline processing within the processor sub-system 101; and the output data generated from processing the input data 114 retrieved from the memory sub-system 103 can be written back to the memory sub-system 103 after a number of clock cycles of pipeline processing within the processor sub-system 101.

Optionally, the input data retrieved from the memory sub-systems 103 and 105 can be combined via the pipeline processing in the processor sub-system 101 to generate output data to be written into one or more of the memory sub-systems 103 and 105.

For example, the input data 111 and 114 can be combined in the processor sub-system 101 to generate output data that is written into the memory sub-system 105 (or memory sub-system 103) after a number of clock cycles.

FIG. 1 illustrates an example where when one connection (e.g., 102) is propagating input data toward the processor sub-system 101, the other connection (e.g., 104) is propagating output data away from the processor sub-system 101. Alternatively, when one connection (e.g., 102) is propagating input data toward the processor sub-system 101, the other connection (e.g., 104) is propagating input data into the processor sub-system 101; and thus, the memory sub-systems 103 and 105 can be read or written in unison in some clock cycles.

In general, the directions of communications over the connections 102 and 104 can be predetermined by a data movement manager. The data movement manager can allocate the directions of communications for the connections 102 to best utilize the communication bandwidth of the connections 102 and 104 for improved overall performance of the system.

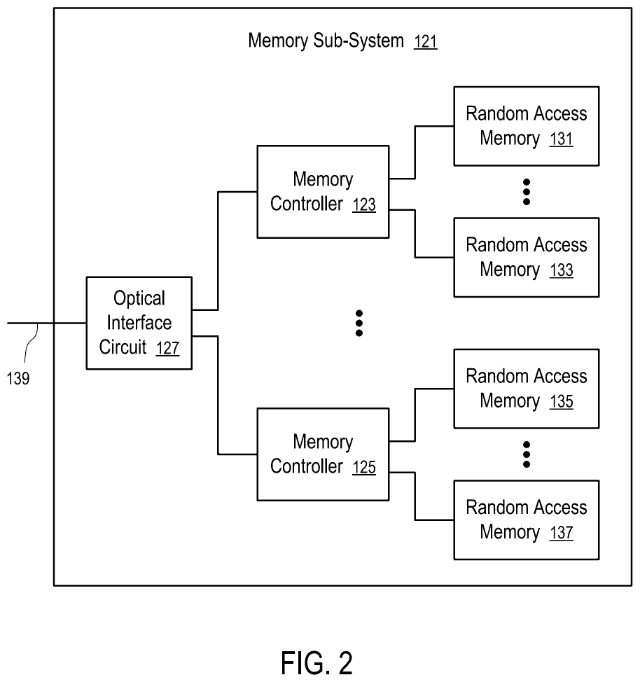

FIG. 2 shows a memory sub-system configured to facilitate systolic memory access according to one embodiment. For example, the memory sub-systems 103 and 105 in FIG. 1 can be implemented in a way as in FIG. 2.

In FIG. 2, the memory sub-system 121 includes an optical interface circuit 127 to transmit or receive data via a ribbon 139 of one or more optical fibers. For example, the connections 102 and 104 in FIG. 1 can be implemented using the ribbons (e.g., 139) of optical fibers when the memory sub-systems 103 and 105 and the processor sub-system 101 are configured with optical interface circuits (e.g., 127).

The optical interface circuit 127 can have one or more buffers for a plurality of memory controllers 123, . . . , 125. The memory controllers 123, . . . , 125 can operate in parallel to move data between the optical interface circuit 127 and the random access memory 131, . . . , 133; . . . ; 135, . . . , 137 controlled by the respective memory controllers 123, . . . , 125.

Optionally, a same read (or write) command can be applied to the plurality of memory controllers 123, . . . , 125. The read (or write) command specifies a memory address. Each of the memory controllers 123, . . . , 125 can execute the same command to read data from (or write data into) the same memory address in a respective memory (e.g., 131, . . . , 135) for high bandwidth memory access through the optical interface circuit 127.

Optionally, each of the random access memories (e.g., 131, . . . , 133) can have a same addressable memory address; and the memory controller 123 can operate the random access memories (e.g., 131, . . . , 133) in parallel to read or write data at the memory address across the memories (e.g., 131, . . . , 133) for improved memory access bandwidth.

Alternatively, the memory controllers 123, . . . , 125 can be controlled via different read commands (or write commands) (e.g., directed at different memory addresses).

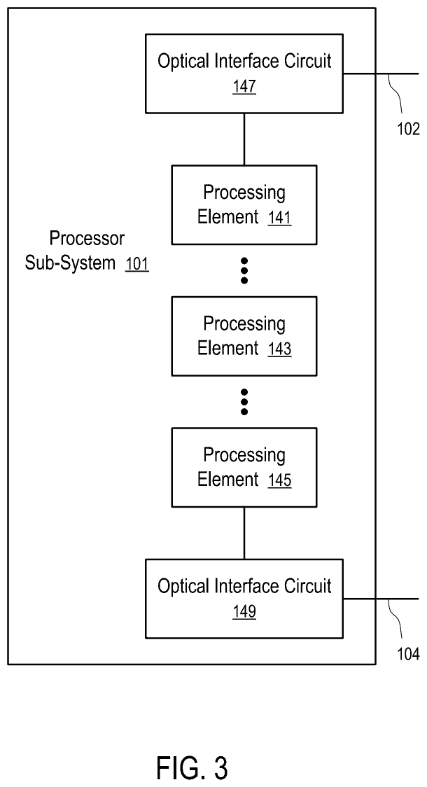

FIG. 3 shows a processor sub-system configured to facilitate systolic memory access according to one embodiment. For example, the processor sub-system 101 in FIG. 1 can be implemented in a way as in FIG. 3.

In FIG. 3, the processor sub-system 101 includes optical interface circuits 147 and 149 to transmit or receive data via connections 102 and 104 that can be implemented via ribbons 139 of one or more optical fibers.

The optical interface circuit 127 can have one or more buffers for a plurality of processing elements 141, . . . , 143, . . . , and 145.

The processing elements 141, . . . , 143, . . . , and 145 can be configured to form a pipeline to process input data (e.g., 114 as in FIG. 1) received over the connection 102 to generate output data (e.g., 112 in FIG. 1) on the connection 104.

Similarly, the processing elements 141, . . . , 143, . . . , and 145 can be configured to form another pipeline to process input data (e.g., 111 as in FIG. 1) received over the connection 104 to generate output data (e.g., 113 in FIG. 1) on the connection 102.

In some implementations, the processing pipelines implemented via the processing elements 141, . . . , 143, . . . , and 145 are hardwired; and the propagation of data among the processing elements 141, . . . , 143, . . . , and 145 are predetermined for the clock cycles (e.g., T1 and T2) in a way similar to the directions of communications of the connections 102 and 104.

In other implementations, the processing pipelines implemented via the processing elements 141, . . . , 143, . . . , and 145 can be programmed via a host system; and the propagation of data among the processing elements 141, . . . , 143, . . . , and 145 can be dynamically adjusted from clock cycles to clock cycles (e.g., T1 and T2) to balance the workloads of the processing elements 141, . . . , 143, . . . , and 145 and the bandwidth usages of the connections 102 and 104.

Optionally, the processing elements 141, . . . , 143, . . . , and 145 can be programmed via a host system to perform parallel operations.

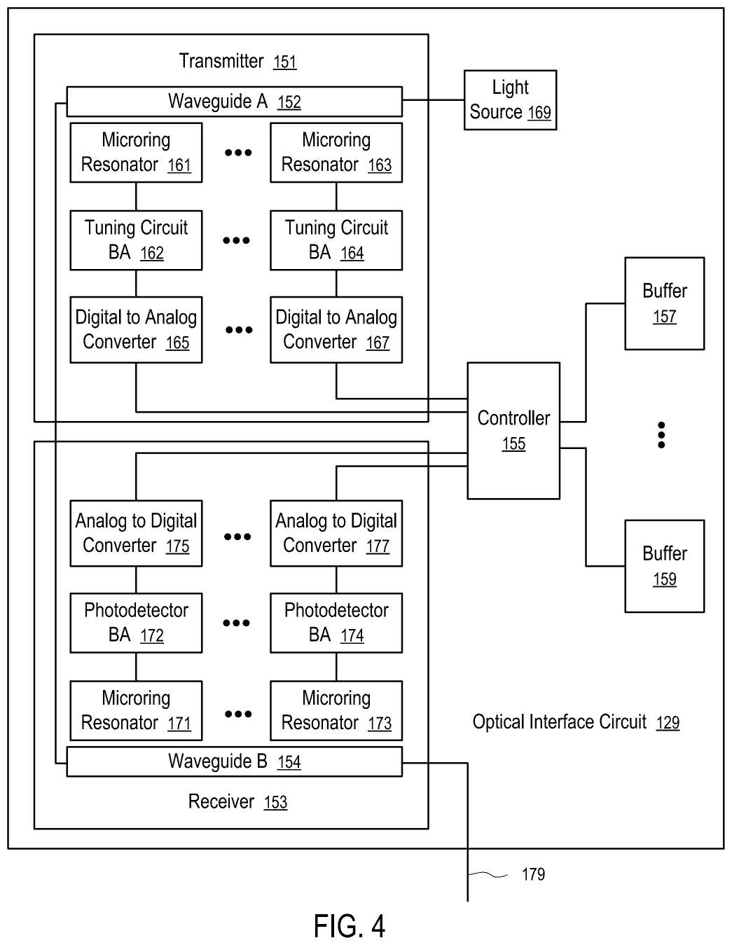

FIG. 4 shows an optical interface circuit operable in a system of systolic memory access according to one embodiment.

For example, the optical interface circuits 127, 147, and 149 in FIG. 2 and FIG. 3 can be implemented as in FIG. 4.

In FIG. 4, the optical interface circuit 129 includes a transmitter 151, a receiver 153, a controller 155, and one or more buffers 157, . . . , 159.

An optical fiber ribbon 179 can be connected to a waveguide 154 configured in the receiver 153, and a waveguide 152 configured in the transmitter 151. The waveguides 152 and 154 are connected to each other in the optical interface circuit 129 to provide an optical signal path between a light source 169 and the optical fiber ribbon 179.

The transmitter 151 and the receiver 153 are configured to transmit or receive data in response to the optical interface circuit 129 being in a transmission mode or a reception mode.

When the optical interface circuit 129 is in a transmission mode, the transmitter 151 is in operation to transmit data. Unmodulated optical signals from the light source 169 can propagate to the waveguide 152 in the transmitter 151 for modulation and transmission through the waveguide 154 in the receiver and the optical fiber ribbon 179. Optionally, the receiver 153 can operate when the optical interface circuit 129 is in the transmission mode to detect the optical signals modulated by the transmitter 151 for the controller 155 to verify the correct transmission of data by the transmitter 151.

When the optical interface circuit 129 is in a reception mode, the receiver 153 is in operation to receive data. Modulated optical signals propagating from the optical fiber ribbon 179 into the waveguide 154 of the receiver 153 can be detected in the receiver 153. Signals passing through the waveguides 154 and 152 can be absorbed for termination. For example, during the reception mode of the optical interface circuit 129, the light source 169 can be configured to stop outputting unmodulated optical signals and to absorb the optical signals coming from the waveguide 152. Optionally, the transmitter 151 can be configured to perform operations to attenuate the signals going through the waveguide 152 when the optical interface circuit 129 is in the reception mode.

The light source 169 can be configured as part of the optical interface circuit 129, as illustrated in FIG. 4. Alternatively, the optical interface circuit 129 can include an optical connector for connecting an external light source 169 to the waveguide 152 (e.g., in a way similar to the connection of the optical fiber ribbon 179 to the waveguide 154).

The transmitter 151 can have a plurality of microring resonators 161, . . . , 163 coupled with the waveguide 152 to modulate the optical signals passing through the waveguide 152. A microring resonator (e.g., 161 or 163) can be controlled via a respective tuning circuit (e.g., 162 or 164) to change the magnitude of the light going through the waveguide 152. A tuning circuit (e.g., 162 or 164) of a microring resonator (e.g., 161 or 163) can change resonance characteristics of the microring resonator (e.g., 161 or 163) through heat or carrier injection. Changing resonance characteristics of the microring resonator (e.g., 161 or 163) can modulate the optical signals passing through waveguide 152 in a resonance frequency/wavelength region of the microring resonator (e.g., 161 or 163). Different microring resonators 161, . . . , 163 can be configured to operate in different frequency/wavelength regions. The technique of wavelength division multiplexing (WDM) allows high bandwidth transmissions over the connection from waveguide 152 through the ribbon 179.

During the transmission mode, the controller 155 (e.g., implemented via a logic circuit) can apply data from the buffers 157, . . . , 159 to the digital to analog converters 165, . . . , 167. Analog signals generated by the digital to analog converters 165, . . . , 167 control the turning circuits 162 in changing the resonance characteristics of the microring resonators 161, . . . , 163 and thus the modulation of optical signals passing through the waveguide 152 for the transmission of the data from the buffers 157, . . . , 159.

The receiver 153 can have a plurality of microring resonators 171, . . . , 173 coupled with the waveguide 154 to detect the optical signals passing through the waveguide 154. Different microring resonators 171, . . . , 173 can be configured to operate in different frequency/wavelength regions to generate output optical signals through resonance. Photodetectors 172, . . . , 174 can measure the output signal strengths of the microring resonators 171, . . . , 173, which correspond to the magnitude-modulated optical signals received from the optical fiber ribbon 179. Analog to digital converters 175, . . . , 177 convert the analog outputs of the photodetectors 172, . . . , 174 to digital outputs; and the controller 155 can store the digital outputs of the analog to digital converters 175, . . . , 177 to the buffers 157, . . . , 159.

In some implementations, when the optical interface circuit 129 is configured for the memory sub-system 121 of FIG. 2, the optical interface circuit 129 can optionally be configured to have a plurality of buffers 157, . . . , 159 accessible, in parallel, respectively by the plurality of memory controllers 123, . . . , 125 in the memory sub-system 121 for concurrent operations (e.g., reading data from or writing data to the buffers 157, . . . , 159).

In some implementations, when the optical interface circuit 129 is configured for the processor sub-system 101 of FIG. 3, the optical interface circuit 129 can optionally be configured to have a plurality of buffers 157, . . . , 159 accessible, in parallel, respectively by a plurality of processing elements 141, . . . , 143, . . . , 145 for concurrent operations (e.g., reading data from or writing data to the buffers 157, . . . , 159).

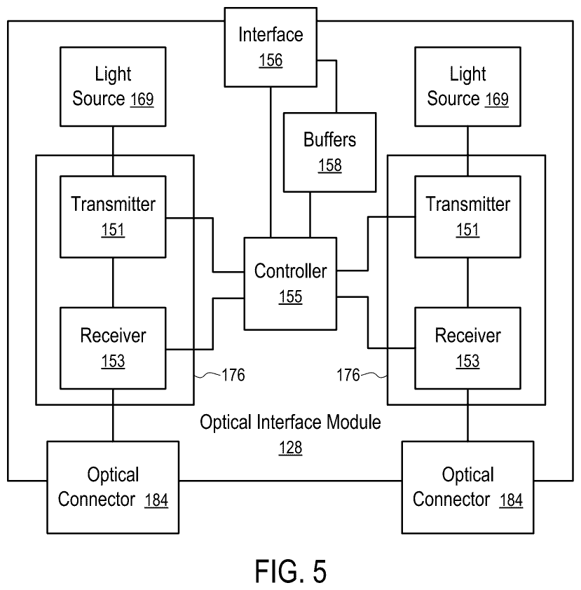

FIG. 5 shows an optical interface module 128 according to one embodiment. For example, the optical interface circuits 127, 147 and 149 in FIG. 2 and FIG. 3 can be implemented via the optical interface module 128 of FIG. 5.

In FIG. 5, the optical interface module 128 includes two sets of electro-optical circuits, each containing a light source 169, an optical transceiver 176 having a transmitter 151 and a receiver 153, and an optical connectors 184. For example, the transmitters 151 and receivers 153 of the optical interface module 128 can be implemented in a way as illustrated in FIG. 4.

Each set of the electro-optical circuits has a waveguide (e.g., including 152, 154 as in FIG. 4) that is connected from the optical connector 184 through the receiver 153 and the transmitter 151 to the light source 169, as in FIG. 4.

A controller 155 of the optical interface module 128 can control the operating mode of each set of the electro-optical circuits to either transmit data from the buffers 158 or receive data into the buffers 158, as in FIG. 4.

An electric interface 156 can be configured to operate the optical interface module 128 as a memory sub-system servicing a host system (or as a host system using the services of one or more memory sub-systems).

For example, the optical interface module 128 can be used to implement the optical interface circuits 147 and 149 of the processor sub-system 101 of FIG. 3 by using the optical connectors 184 for the connections 102 and 104 respectively. The processing elements 141, 145, and optionally other processing elements (e.g., 143) can be each implemented via a system on a chip (SoC) device having a memory controller to read from, or write data to, the interface 156.

For example, the interface 156 can include a plurality of host interfaces for the processing elements 141 and 145 (or 141, . . . , 143, . . . , 145) respectively. The host interfaces can receive read/write commands (or load/store instructions) in parallel as if each of the host interfaces were configured for a separate memory sub-system.

The controller 155 is configured to transmit the commands/instructions and their data received in the host interfaces for transmission at least in part over the optical connectors 184.

Optionally, the optical interface module 128 further includes two electric interfaces for transmission control signals (and addresses) to the memory sub-systems (e.g., 103 and 105) that are connected to the optical connectors 184 respectively.

To enable systolic memory access, the optical interface module 128 can be configured to place the two sets of electro-optical circuits in opposite modes. For example, when one optical connector 184 is used by its connected receiver 153 for receiving data, the other set of electro-optical circuit can be automatically configured by the controller 155 in a transmission mode; and when one optical connector 184 is used by its connected transmitter 151 for transmitting data, the other set of electro-optical circuit can be automatically configured by the controller 155 in a reception mode.

In another example, the optical interface module 128 can be used to implement the optical interface circuit 127 of the memory sub-system 121 of FIG. 2 by attaching one of the optical connectors 184 to the ribbon 139 of one or more optical fibers. Optionally, the other optical connector 184 of the optical interface module 128 can be connected to another ribbon that is in turn connected to another processor sub-system (e.g., similar to the connection to the processor sub-system 101 in FIG. 1). Thus, the memory sub-system 121 can be chained between two processor sub-systems (e.g., 101); and the chain of memory sub-systems to processor sub-systems can be extended to include multiple processor sub-systems and multiple memory sub-systems, where each processor sub-system is sandwiched between two memory sub-systems. Optionally, the chain can be configured a closed loop, where each memory sub-system is also sandwiched between two processor sub-system 101.

Optionally, when used in a memory sub-system 121, the interface 156 can include a plurality of memory interfaces. Each of the memory interfaces can operate as a host system to control a memory controller (e.g., 123 or 125) by sending read/write commands (or store/load instructions) to the memory controller (e.g., 123 or 125). Thus, each of the memory controllers (e.g., 123) and its random memory (e.g., 131, . . . , 133) in the memory sub-system 121 can be replaced with, or be implemented using, a conventional memory sub-system, such a solid state drive, a memory module, etc.

Alternatively, when used in a memory sub-system 121, the interface 156 can be simplified as connections for the memory controllers 123, . . . , 125 to directly access respective buffers 158 (e.g., 157, . . . , 159) in the optical interface module 128.

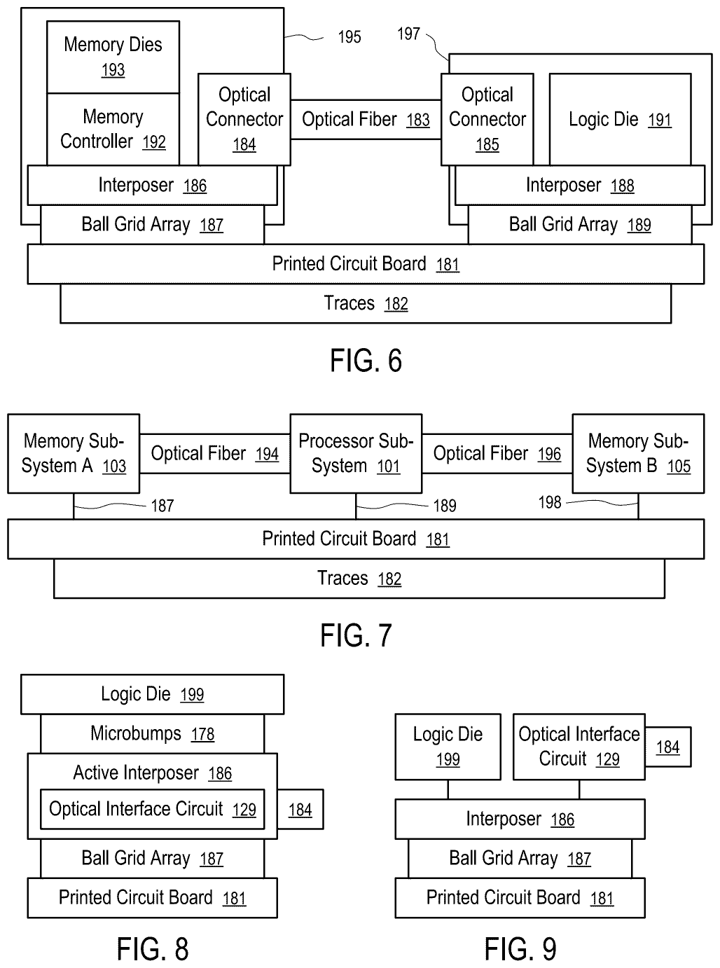

FIG. 6 shows a configuration to connect a memory sub-system and a processor sub-system according to one embodiment. For example, the connection 102 between the memory sub-system 103 and the processor sub-system 101 in FIG. 1 can be implemented using the configuration of FIG. 6. For example, the connection 104 between the memory sub-system 105 and the processor sub-system 101 in FIG. 1 can be implemented using the configuration of FIG. 6.

In FIG. 6, a memory sub-system (e.g., 103 or 105) can be enclosed in an integrated circuit package 195; and a processor sub-system 101 can be enclosed in another integrated circuit package 197.

Within the integrated circuit package 195, the memory sub-system (e.g., 103, 105, or 121) includes an interposer 186 configured to provide an optical connector 184 to an optical fiber 183 (e.g., ribbon 139 or 179). Data to be transmitted to, or received in, the buffers (e.g., 157, . . . , 159) of an optical interface circuit 129 of the memory sub-system is configured to be communicated through the optical fiber 183 over the optical connector 184. Control signals and power are configured to be connected to the memory sub-system via traces 182 configured on the printed circuit board 181. The optical fiber 183 can be configured in a ribbon that is separate from the printed circuit board 181.

Similarly, within the integrated circuit package 197, the processor sub-system (e.g., 101) includes an interposer 188 configured to provide an optical connector 185 to the optical fiber 183 (e.g., ribbon 179). Data to be transmitted to, or received in, the buffers (e.g., 157, . . . , 159) of an optical interface circuit 129 of the processor sub-system is configured to be communicated through the optical fiber 183 over the optical connector 185. Control signals and power are configured to be connected to the processor sub-system via traces 182 configured on the printed circuit board 181. The optical fiber 183 can be configured in a ribbon that is separate from the printed circuit board 181.

In FIG. 6, both the package 195 of the memory sub-system and the package 197 of the processor sub-system are mounted on a same printed circuit board 181 that has traces 182 configured to route signals for control (e.g., clock) and power.

The communications over the optical fiber 183 can be at a clock frequency that is multiple times of the frequency of the clock signals (e.g., times T1 and T2 in FIG. 1) transmitted over the traces 182 and used to control the communication directions in the optical fiber 183.

Each of the memory sub-system enclosed within the package 195 and the processor sub-system enclosed within the package 197 can include an optical interface circuit (e.g., 129) to bridge the optical signals in the optical fiber 183 and electrical signals in the memory/processor sub-system.

Control signals and power can be connected via traces 182 through a ball grid array 187 (or another integrated circuit chip mounting technique) and the interposer 186 to the controller 155 of the optical interface circuit 129 of the memory sub-system and the memory controllers (e.g., 192) in the memory sub-system. The memory sub-system can have one or more memory dies 193 stacked on a logic die in which the memory controllers (e.g., 192) are formed.

Similarly, control signals and power can be connected via traces 182 through a ball grid array 189 (or another integrated circuit chip mounting technique) and the interposer 188 to the controller 155 of the optical interface circuit 129 of the processor sub-system and the logic die 191 of the processor sub-system.

FIG. 7 shows a configuration to connect memory sub-systems and a processor sub-system for systolic memory access according to one embodiment. For example, the memory sub-systems 103 and 105 and the processor sub-system 101 in FIG. 1 can be connected in a configuration of FIG. 7.

In FIG. 7, the memory sub-systems 103 and 105 and the processor sub-system 101 are mounted on a same printed circuit board 181 for control and power. For examples, the memory sub-systems 103 and 105 and the processor sub-system 101 can be each enclosed within a single integrated circuit package and connected to the traces 182 on the printed circuit board 181 via a respective ball grid arrays (e.g., 187, 198, or 198), as in FIG. 6. Alternative techniques for mounting integrated circuit chip on printed circuit boards can also be used.

The traces 182 on the printed circuit board 181 can be used to connect signals (e.g., clock) and power that do not require a high communication bandwidth to the memory sub-systems 103 and 105 and the processor sub-system 101. Ribbons of optical fibers 194 and 196 can be used to connect data, address, and/or command communications between the processor sub-system 101 and the memory sub-systems 103 and 105.

For example, the memory sub-system 103 and the processor sub-system 101 can be connected in a way as illustrated in FIG. 6; and the memory sub-system 105 and the processor sub-system 101 can be connected in a way as illustrated in FIG. 6. The interposer 188 in the processor sub-system 101 can have two optical connectors (e.g., 185): one connected to the optical fiber 194, and the other to the optical fiber 196.

In some implementations, the communication directions in the optical fibers (e.g., 194 and 196) are predetermined for clock cycles.

For example, in odd numbered clock cycles, the optical interface circuit 129 in the memory sub-system 103 is in a transmission mode; and the optical interface circuit 129 in the processor sub-system 101 and connected to the optical fiber 194 is in a reception mode. Thus, the data transmission in the optical fiber 194 is from the memory sub-system 103 toward the processor sub-system 101. Similarly, in even numbered clock cycles, the optical interface circuit 129 in the memory sub-system 103 is in a reception mode; and the optical interface circuit 129 in the memory sub-system 103 and connected to the optical fiber 194 is in a transmission mode. Thus, the data transmission in the optical fiber 194 is from the processor sub-system 101 toward the memory sub-system 103 toward.

Alternatively, a processor sub-system 101 (or a host system) can use a control signal transmitted over the traces 182 to control the direction of transmission over the optical fiber 194. For example, when a first signal (separate from a clock signal) is sent over the traces 182 to the memory sub-system 103 (e.g., from the processor sub-system 101 or the host system), the optical interface circuit 129 in the memory sub-system 103 is in a transmission mode; and the processor sub-system 101 can receive data from the memory sub-system 103 over the optical fiber 194. When a second signal (separate from a clock signal and different from the first signal) is sent over the traces 182 to the memory sub-system 103 (e.g., from the processor sub-system 101 or the host system), the optical interface circuit 129 in the memory sub-system 103 is in a reception mode; and the processor sub-system 101 can transmit data to the memory sub-system 103 over the optical fiber 194. Thus, the data transmission direction over the optical fiber 194 (or 196) can be dynamically adjusted based on the communication needs of the system.

Data transmitted from the processor sub-system 101 to a memory sub-system 103 (or 105) over an optical fiber 194 (or 196) can include outputs generated by the processor sub-system 101. Optionally, data retrieved from one memory sub-system (e.g., 105) can be moved via the processor sub-system 101 to another memory sub-system (e.g., 103) via an optical fiber (e.g., 194).

Further, data transmitted from the processor sub-system 101 to a memory sub-system 103 (or 105) over an optical fiber 194 can include commands (e.g., read commands, write commands) to be executed in the memory sub-system 103 (or 105) and parameters of the commands (e.g., addresses for read or write operations). Alternatively, the commands can be transmitted via the traces 182, especially when the sizes of the commands (and their parameters) are small, compared to the data to be written into the memory sub-system 103 (or 105). For example, when the memory controllers 123, . . . , 125 can share a same command and an address for their operations in accessing their random access memories (e.g., 131, . . . , 133; or 135, . . . , 137), the size of the command and the address can be smaller when compared to the size of the data to be written or read via the command.

Data transmitted to the processor sub-system 101 from a memory sub-system 103 (or 105) over an optical fiber 194 can include data retrieved from the random access memories 131, . . . , 133, . . . , 135, . . . , 137 in response to read commands from the processor sub-system 101.

The interposers (e.g., 186) of the memory sub-systems 103 and the processor sub-system 101 can be implemented using the technique of FIG. 8 or FIG. 9.

FIG. 8 and FIG. 9 show techniques to connect a logic die to a printed circuit board and an optical fiber according to one embodiment.

In FIG. 8, an active interposer 186 is configured on an integrated circuit die to include active circuit elements of an optical interface circuit 129, such as the transmitter 151 and receiver 153, in addition to the wiring to directly connect the ball grid array 187 to microbumps 178. The active interposer 186 includes the optical connector 184 for a connection to an optical fiber ribbon 179. Optionally, the active interposer 186 further includes the controller 155 and/or the buffers 157, . . . , 159 of the optical interface circuit 129. Alternatively, the controller 155 can be formed on a logic die 199. For example, when the active interposer 186 is used in a processor sub-system 101, the logic die 199 can contain the logic circuits (e.g., processing elements 141, . . . , 143, . . . , or 145) of the processor sub-system 101. For example, when the active interposer 186 is used in a memory sub-system 121, the logic die 199 can contain the logic circuits (e.g., memory controllers 123, . . . , 125) of the memory sub-system 121.

The active interposer 186 is further configured to provide wires for the control and power lines to be connected via the ball grid array 187 through microbumps 178 to the circuitry in the logic die 199.

For example, the active optical interposer 186 can include waveguides 152 and 154, microring resonators 171, . . . , 173 and 161, . . . , 163, digital to analog converters 165, 167, tuning circuits 162, . . . , 164, analog to digital converters 175, . . . , 177, . . . , photodetectors 172, . . . , 174, wire connections via a ball grid array 187 toward traces 182 on a printed circuit board 181, wire connections via microbumps 178 to one or more logic dies 199 (and memory dies 193), wires routed between the wire connections, and a port or connector 184 to an optical fiber (e.g., 183, 194, or 196).

In contrast, FIG. 9 shows a passive interposer 186 configured between a printed circuit board 181 and integrated circuit dies, such as a logic die 199 and a die hosting an optical interface circuit 129 and a port or connection 184 to an optical fiber (e.g., 183, 194, or 196). The passive interposer 186 contains no active elements and is configured to provide wire connections between the circuitry in the logic die 199 and the circuitry in the optical interface circuit 129, and wire connections to the traces 182 on the printed circuit board 181.

In some implementations, an optical interface module 128 is configured as a computer component manufactured on an integrated circuit die. The optical interface module 128 includes the optical interface circuit 129 formed on a single integrated circuit die, including at least one optical connector 184 and optionally, a light source 169 for the transmitter 151. Optionally, the optical interface module 128 includes the wires and connections of the active interposer 186 that are not directly connected to the optical interface circuit 129. Alternatively, the optical interface module 128 is configured to be connected to other components of a memory sub-system (e.g., 121) (or a processor sub-system (e.g., 101)) via a passive interposer 186, as in FIG. 9.

In one embodiment, an optical interface module 128 is configured to provide access, via an optical fiber 183, multiple sets of memories (e.g., 131, . . . , 133; . . . , 135, . . . , 137), each having a separate memory controller (e.g., 123, or 125). The multiple sets of memories (e.g., 131, . . . , 133; . . . , 135, . . . , 137) and their memory controllers (e.g., 123, . . . , 125) can be configured to be enclosed within multiple integrated circuit packages to form multiple memory chips. Each of the integrated circuit packages is configured to enclose a set of memories (e.g., 131, . . . , 133) formed on one or more memory dies 193 and to enclose a memory controller 192 formed on a logic die (e.g., 199) (or a portion of the memory dies 193). Optionally, the optical interface module 128 can be configured as a host of the memory chips, each enclosed within an integrated circuit package. The optical interface module 128 can write data received from the optical fiber 183 into the memory chips during one clock cycle, and transmit data retrieved from the memory chips into the optical fiber 183 during another clock cycle. Each of the memory chips can operate independent from other memory chips. Optionally, each of the memory chips can be replaced with a memory sub-system. The optical interface module 128 can be configured to optionally access the memory chips or memory sub-systems in parallel for improved memory throughput. For example, a memory sub-system 103 or 105 in FIG. 1 and FIG. 7 can be implemented with the combination of the memory chips (or memory sub-systems) controlled by an optical interface module 128 functioning as a host system of the memory chips (or memory sub-systems) for an increased memory capacity and an increased access bandwidth.

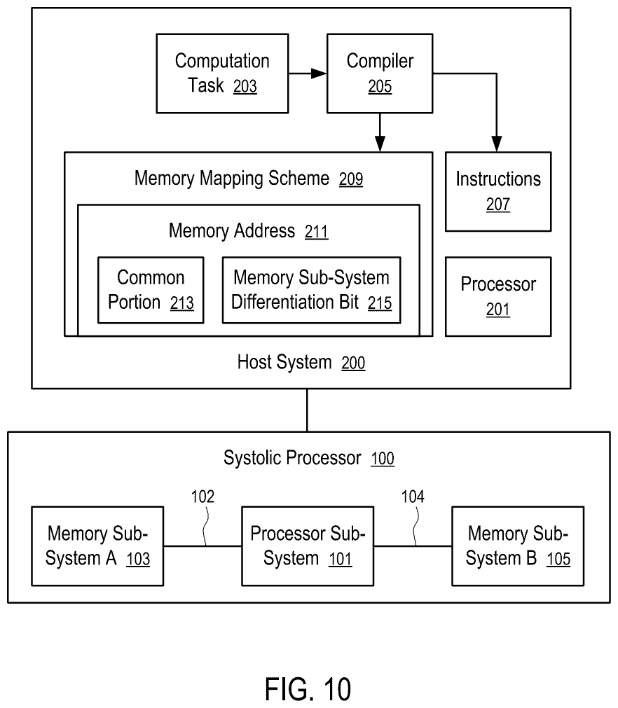

To best utilize the high memory access bandwidth offered by the memory sub-systems 103 and 105 over optical fibers 194 and 196, a memory manager can be configured to generate a memory mapping scheme with corresponding instructions for the processor sub-system 101, as in FIG. 10.

FIG. 10 shows a technique to use a compiler to configure the operations of systolic memory access according to one embodiment.

For example, the technique of FIG. 10 can be used to control the operations of a processor sub-system 101 to access memory sub-systems 103 and 105 of FIG. 1 and FIG. 7.

In FIG. 10, a systolic processor 100 includes a processor sub-system 101 connected to separate memory sub-systems 103 and 105, as in FIG. 1 and FIG. 7. A host system 200 can control the memory access pattern in the systolic processor 100.

For example, a compiler 205 can be configured as a memory manager running in the host system 200 to schedule the data and workload flow in the hardware of the systolic processor 100 to best utilize the hardware capability. The compiler 205 can be configured to generate a static memory mapping scheme 209 for a given computation task 203. The compiler 205 can be configured to try different approaches of using the memory provided by the memory sub-systems 103 and 105, and schedule the read/write commands to meet various timing requirements, such as the latency requirements of the memory sub-systems 103 and 105 in performing the read/write operations, and data usage and processing timing requirements of processors/processing elements 141, . . . , 143, . . . , 145 in the processor sub-system 101, etc. The compiler 205 can select a best performing solution to control the activities of the processor sub-system 101.

The computation task 203 can be programmed in a way where memory resources are considered to be in a same virtual memory system. The compiler 205 is configured to map the memory resources in the same virtual memory system into the two memory sub-systems 103 and 105 via a memory mapping scheme 209. A memory address in the virtual memory system can be used as the common portion 213 of a memory address 211 used to address the memory sub-systems 103 or 105. A memory sub-system differentiation bit 215 is included in the memory address 211 to indicate whether the memory address 211 is in the memory sub-system 103 or in the memory sub-system 105.

For example, when the memory sub-system differentiation bit 215 has the value of zero (0), the memory address 211 is in the memory sub-system 103. The processor sub-system 101 can provide the common portion 213 of the memory address 211 to read or write in the memory sub-system 103 at a corresponding location represented by the common portion 213 of the memory address 211.

When the memory sub-system differentiation bit 215 has the value of one (1), the memory address 211 is in the memory sub-system 105. The processor sub-system 101 can provide the common portion 213 of the memory address 211 to read or write in the memory sub-system 105 at a corresponding location represented by the common portion 213 of the memory address 211.

The common portion 213 of the memory address 211 can be programmed in, or mapped from a virtual memory address specified in, the computation task 203. The compiler 205 can determine the memory sub-system differentiation bit 215 to map the address 211 to either the memory sub-system 103 or the memory sub-system 105. The processor sub-system 101 can execute the instructions 207 of the computation task 203 to access the memory sub-system 103 or the memory sub-system 105 according to the differentiation bit 215.

Optionally, the differentiation bit 215 of some memory addresses (e.g., 211) can be computed by the processor sub-system 101 in execution of the instructions 207 configured by the compiler 205 to best utilize the memory access bandwidth offered by the connections 102 and 104.

In one implementations, a memory location in the memory sub-system 103 can have a same physical address, represented by the common portion 213, as a corresponding memory location in the memory sub-system 105. To differentiate between the two memory locations in the memory sub-systems 103 and 105 respectively, the systolic processor 100 can be configured to use an additional differentiation bit 215 based on the commands generated by compute nodes, such as system on a chip (SoC) devices in the processor sub-system 101. The compute nodes (e.g., SoC devices) can generate memory addresses (e.g., 211) with this separate/additional differentiation bit (e.g., 215) to indicate whether a memory operation is to be in the memory sub-system 103 or 105. A controller (e.g., 155) in the processor sub-system 101 consumes the differentiation bit 215 to direct the corresponding operation to either the memory sub-system 103 or 105 with the remaining bits of memory addresses (e.g., common portion 213) being provided by the processor sub-system 101 to address a memory location in the memory sub-system 103 or 105.

The compiler 205 can be configured with an internal mapping of the hardware of the systolic processor 100 and a transaction level model (TLM) of the hardware. The compiler 205 can determine, for the given computation task 203, the read and write latency tolerances and decide how to map and extract data using systolic data movements. When a memory sub-system 103 or 105 is implemented via multiple, separate memory chips (or sub-systems), memory virtualizer can be used to view the memory capacity of a collection of memory chips (or sub-systems) as a contiguous memory block to assist in generating the physical addresses used in the static memory mapping scheme 209.

Optionally, the compiler 205 can be configured to instruct the systolic processor 100 to read from one memory sub-system (e.g., 103) and then write to another (e.g., 105).

For example, in an application configured to the process of the training of an artificial neural network model, the neuron weights can be initially stored in a memory sub-system (e.g., 103); and the updated neuron weights computed by the processor sub-system 101 can be written to the corresponding locations in the other memory sub-system (e.g., 105). Subsequently, the roles of the memory sub-systems 103 and 105 can be reversed for the flowing of weight data in the opposite direction.

The differentiation bit 215 configured for controlling the selection of a memory sub-system (e.g., 103 or 105) can be used by a controller 155 of the optical interface circuits 129 of the processor sub-system 101 to select the memory sub-system (e.g., 103 or 105) currently being addressed. For example, registers (or using scratch pad memory) in the controller 155 of the optical interface module 128 of the processor sub-system 101 can be configured to identify the currently selected memory sub-system (e.g., 103 or 105) for write or read by the processor sub-system 101. For example, a bit value of zero (0) can be used to indicate that the memory sub-system 103 is to be read from, while the memory sub-system 105 is to be written into; alternatively, a bit value of one (1) can be used to indicate writing to the memory sub-system 105 while reading from memory sub-system 103. Such a register can be masked on to an outbound read/write request enabling the routing/selection of the correct memory destination. The system does not require changes to the memory controllers in the system on a chip (SoC) devices of the processor sub-system 101, but relies on the controller 155 of the optical interface circuits 129 of the processor sub-system 101.

In some implementations, the processor 201 can be configured to send signals through the traces 182 in the printed circuit board 181 (e.g., as in FIG. 7) of the systolic processor 100 to control the communication directions in the connections 102 and 104.

In one embodiment, a method is provided to facilitate systolic memory access according to one embodiment.

For example, the method of systolic memory access can be implemented in a computing system of FIG. 10, where the systolic processor 100 can be configured on a printed circuit board 181 in a configuration illustrated in FIG. 7.

For example, the method of systolic memory access includes: connecting a processor sub-system 101 between a first memory sub-system 103 and a second memory sub-system 105; receiving a first clock signal (e.g., identifying a time period T1); and configuring, in response to the first clock signal, a communication direction of a first connection 102 between the processor sub-system 101 and the first memory sub-system 103 to receive first data 114 in the processor sub-system 101 from the first memory sub-system 103.

For example, the first data 114 can include data retrieved from the first memory sub-system 103 after execution of read commands (e.g., transmitted to the first memory sub-system 103 in a time period identified by a previous clock signal).

Further, the method of systolic memory access includes configuring, in response to the first clock signal, a communication direction of a second connection 104 between the processor sub-system 101 and the second memory sub-system 105 to transmit second data 112 from the processor sub-system 101 to the second memory sub-system 105.

For example, the second data 112 can include data to be written via execution of write commands in the second memory sub-system 105.

Optionally, the second data 112 can include data representative of read commands to retrieve data from the second memory sub-system 105. For example, after the execution of the read commands, the retrieved data can be communicated from the second memory sub-system 105 to the processor sub-system 101 after the communication direction in the connection 104 is reversed in response to a subsequent clock signal.

Optionally, the second data 112 can include data representative of addresses for execution of read commands and/or write commands in the second memory sub-system.

Further, the method of systolic memory access includes receiving a second clock signal (e.g., identifying a time period T2), and reversing, in response to the second clock signal, the communication direction of the first connection 102 and the communication direction of the second connection 104.

For example, the reversing can be predetermined for the second clock signal being an odd-number clock signal (or an even-number clock signal) transmitted on traces 182 on a printed circuit board 181.

For example, the first connection 102 and the second connection 104 are implemented via optical fibers 194 and 196 configured in ribbons that separate from the printed circuit board 181.

For example, the processor sub-system 101, the first memory sub-system 103, and the second memory sub-system 105 are mounted on a same printed circuit board 181.

For example, the first clock signal and the second clock signal are provided to the processor sub-system 101, the first memory sub-system 103, and the second memory sub-system 105 via traces 182 on the printed circuit board 181.

Optionally, the method of systolic memory access can include: transmitting a read command using the traces 182 on the printed circuit board 181 to receive the first data from the first memory sub-system 103; and transmitting a write command using the traces 182 on the printed circuit board 181 to write the second data 112 into the second memory sub-system 105.

Optionally, the method of systolic memory access can include: transmitting a first address using the traces 182 on the printed circuit board 181 to receive the first data from the first memory sub-system 103; and transmitting a second address using the traces 182 on the printed circuit board 181 to write the second data 112 into the second memory sub-system 105.

For example, the first memory sub-system 103, the second memory sub-system 105 and the processor sub-system 101 can each be implemented via a device having: one or more buffers (e.g., 158; or 157, . . . , 159); an optical receiver 153; an optical transmitter 151; and an optical connector 184. The optical connector 184 is operable to an optical fiber (e.g., 194 or 196) to the optical transmitter 151 through the optical receiver 153. The device can further include a controller 155 coupled to the one or more buffers (e.g., 158; or 157, . . . , 159) and configured to operate a combination of the optical receiver 153 and the optical transmitter 151 in either a transmission mode or a reception mode.

For example, the optical transmitter 151 is configured to modulate optical signals coming from a light source 169 toward the optical connector 184 in the transmission mode; and the optical receiver 154 is configured to detect optical signals propagating from the optical connector 184 toward the optical transmitter 151 in the reception mode.

Optionally, the optical receiver 153 is configured to detect optical signals coming from the optical transmitter 151 toward the optical connector 184 in the transmission mode; and the controller 155 is configured to detect transmission errors based on signals detected by the optical receiver 153 when the combination of the receiver 153 and the transmitter 151 is in the transmission mode.

Optionally, the optical transmitter is configured to attenuate optical signals passing through the optical transmitter 151 when the combination of the receiver 153 and the transmitter 151 in the reception mode.

For example, the device can include: a logic die 199 containing the controller 155; and an active interposer 186 containing the optical receiver 153, the optical transmitter 151, the optical connector 184, and wires configured to connect a ball grid array 187 to the logic die 199. The wires can go through the active interposer 186 without being connected to any of the optical receiver 153, and the optical transmitter 151.

Alternatively, the active interposer 186 can include the logic circuits of the controller 155 and optionally, the buffers (e.g., 157, . . . , 159; 158).

In some implementations, a non-transitory computer storage medium is configured to store instructions which, when executed in a computing device (e.g., as in FIG. 10), cause the computing device to perform a method, including compiling a program of a computation task 203 based on a transaction level model of a systolic processor 100 having the processor sub-system 101 connected to at least two separate memory sub-systems, such as the first memory sub-system 103 and the second memory sub-system 105. The method can further include: mapping, based on the compiling, memory addresses in the program of the computation task 203 to the two memory sub-systems 103 and 105; and generating instructions for the systolic processor 100 to read from the first memory sub-system 103 and write to the second memory sub-system 105 in a first set of predetermined clock cycles (e.g., T1, or odd-numbered clock cycles), and to write to the first memory sub-system 103 and read from the second memory sub-system 105 in a second set of predetermined clock cycles (e.g., T2, or even-numbered clock cycles). The first set of predetermined clock cycles and the second set of predetermined clock cycles are mutually exclusive.

Optionally, the method can further include: adding a memory sub-system differentiation bit 215 to a memory address (e.g., common portion 213) in the program of the computation task 203. When the memory sub-system differentiation bit 215 has a first value (e.g., zero), the memory address (e.g., common portion 213) is in the first memory sub-system 103. When the memory sub-system differentiation bit 215 has a second value (e.g., one), the memory address (e.g., common portion 213) is in the second memory sub-system 105. The systolic processor 100 can access either the first memory sub-system 103, or the second memory sub-system 105, according to the memory address (e.g., common portion 213) based on the value of the memory sub-system differentiation bit 215.

Optionally, the compiler 205 can configure instructions 207 to be executed by the processor sub-system 101 to generate the memory sub-system differentiation bit 215 for a memory address (e.g., common portion 213) used to access memory. When the memory sub-system differentiation bit 215 has a first value (e.g., zero), the memory address (e.g., common portion 213) is accessed by the processor sub-system 101 in the first memory sub-system 103; and when the memory sub-system differentiation bit 215 has a second value (e.g., one), the memory address (e.g., common portion 213) is accessed by the processor sub-system 101 in the second memory sub-system 105.

For example, memory access requests can be buffered in an optical interface module 128 of the processor sub-system 101 for communication with the memory sub-system 103 and 105 based on the timing of the communication directions of the connections 102 and 104, and the memory sub-system differentiation bit 215 attached to a memory address (e.g., common portion 213) that is accessible in both memory sub-systems 103 and 105.

At least some embodiments disclosed herein relate to photonic channels routed through a photonic switch to connect processing elements (e.g., 141, 143, . . . , 145) of a processor sub-system 101 with sections of memories allocated from different memory sub-systems to the respective processing elements (e.g., 141, 143, . . . , 145).

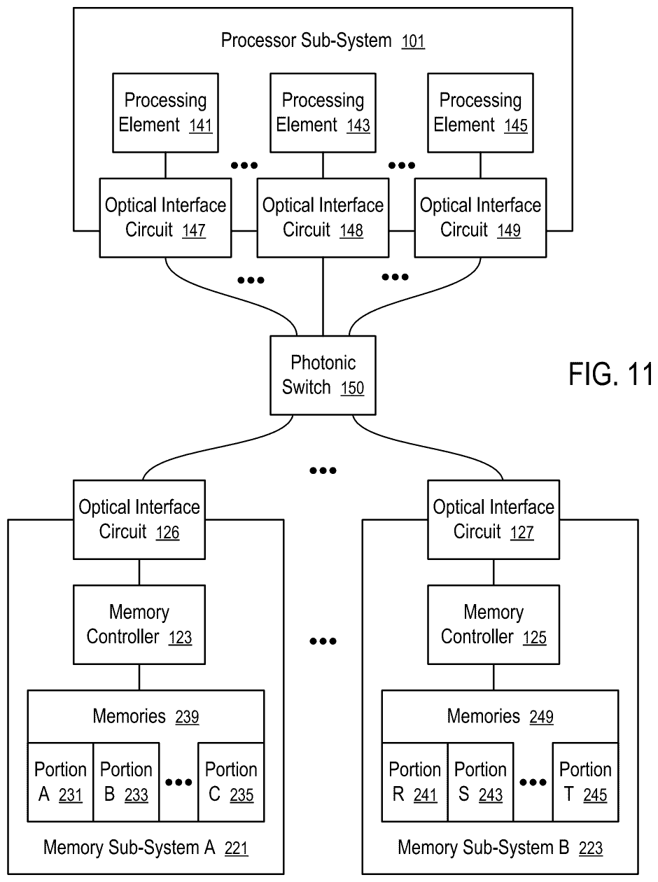

FIG. 11 shows a processor sub-system having processing elements configured to access memories allocated from a plurality of memory sub-systems according to one embodiment.

In FIG. 11, a processor sub-system 101 can have a plurality of processing elements 141, . . . , 143, . . . , 145. For example, each of the processing elements (e.g., 141, 143, or 145) can be implemented as a system on a chip (SoC) device that can function as a host system. Optionally, the processor sub-system 101 can be a cluster of host systems, each configured with one or more processing devices as a processing element (e.g., 141, . . . , 143, . . . , or 145) in the processor sub-system 101.

In FIG. 11, the processing elements 141, . . . , 143, . . . , 145 are connected to a plurality of optical interface circuits 147, 148, . . . , 149 respectively to access memory services provided by a plurality of memory sub-systems 221, . . . , 223. For example, each of the memory sub-systems 221, . . . , 223 can be configured as a solid state drive, a hand bandwidth memory (HBM) module, etc.

Each of the optical interface circuits 147, . . . , 148, . . . , 149 can function as a host interface of a virtual memory sub-system to receive memory access requests from a respective processing element (e.g., 141, . . . , 143, . . . , or 145) and to service the memory access requests using a portion of the memory resources allocated from the memory sub-systems 221, . . . , 223 to the respective processing element (e.g., 141, . . . , 143, . . . , or 145).

For example, the memories 239 of the memory sub-system 221 can have portions 231, 233, . . . , 235 that can be allocated to different processing elements 141, . . . , 141, . . . , 145. The memories 249 of the memory sub-system 223 can have portions 241, 243, 245 that are allocated in different ways to some or all of the processing elements 141, . . . , 141, . . . , 145.

Each of the processing elements 141, . . . , 143, . . . , 145 can have a slice of the memories 239, . . . , 249 dynamically allocated from the memory sub-systems 221, . . . , 223 to the respective processing element (e.g., 141, 143, or 145) based on the memory demands of the application(s) running the processing element (e.g., 141, 143, or 145).

For example, when the processing element 141 starts an application, its memory demand can be low; and a portion 231 of memories 239 can be allocated from the memory sub-system 221 to the processing element 141. As the application running in the processing element 141 progresses, the memory demand of the processing element 141 increases; and thus more memory portions (e.g., 245) can be allocated to the processing element 141 from different memory sub-systems (e.g., 223). When the processing element 141 restarts the application, its memory demand can reduce; and some of the memory portions previously allocated to the processing element 141 can be returned (e.g., re-allocated to other processing elements (e.g., 143 or 145)).

The optical interface circuits 147, . . . , 148, . . . , 149, of the processor sub-system 101 and the optical interface circuits 126, . . . , 127 of the memory sub-systems 221, . . . , 223, as connected via the photonic switch 150 in FIG. 11 can be configured to implement a function of a memory manager.

The memory manager can connect the processing element 141 to the slice of the memories 239, . . . , 249, having the portions (e.g., 231, . . . , 245) currently being allocated to processing element 141. The slice can be attached via the optical interface 147 to the processing element, as if the processing element 141 were hardwired, via the optical interface circuit 147 as a host interface, to the portions (e.g., 231, . . . , 245) of the slice configured in a single virtual memory sub-system that were separate from other processing elements (e.g., 143, 145) in the processor sub-system 101.

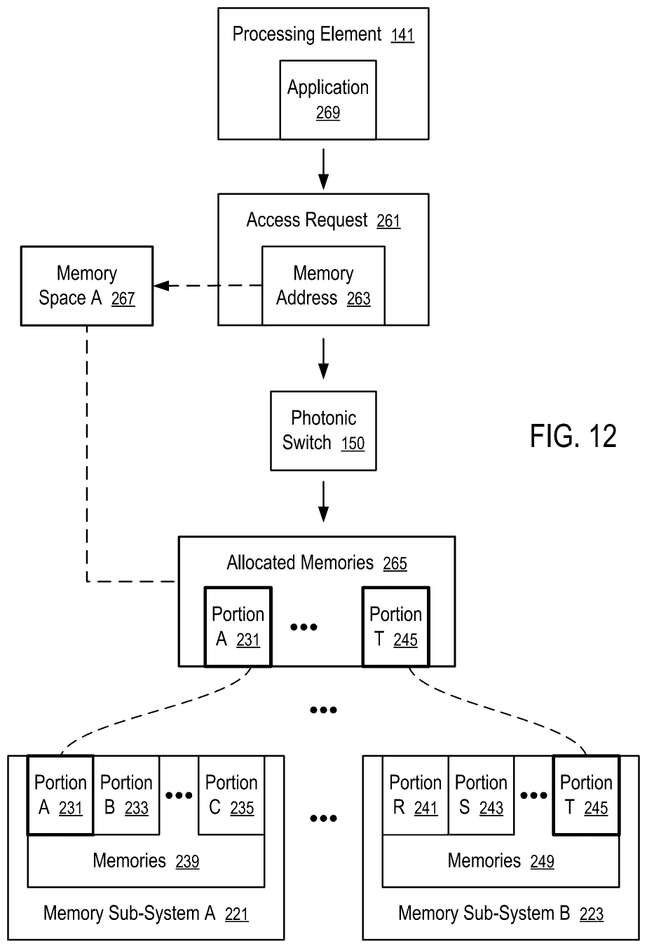

Similarly, the optical interface circuits 147, . . . , 148, . . . , 149, 126, . . . , 127 and the photonic switch 150 can connect another processing element (e.g., 143 or 145) to its slice of the memories 239, . . . , 249 currently allocated from the memory sub-systems 221, . . . , 223, as if the processing element (e.g., 143 or 145) were connected directly to the slice in a single virtual memory sub-system that were separate from other processing elements (e.g., 141) in the processor sub-system 101, as in FIG. 12.

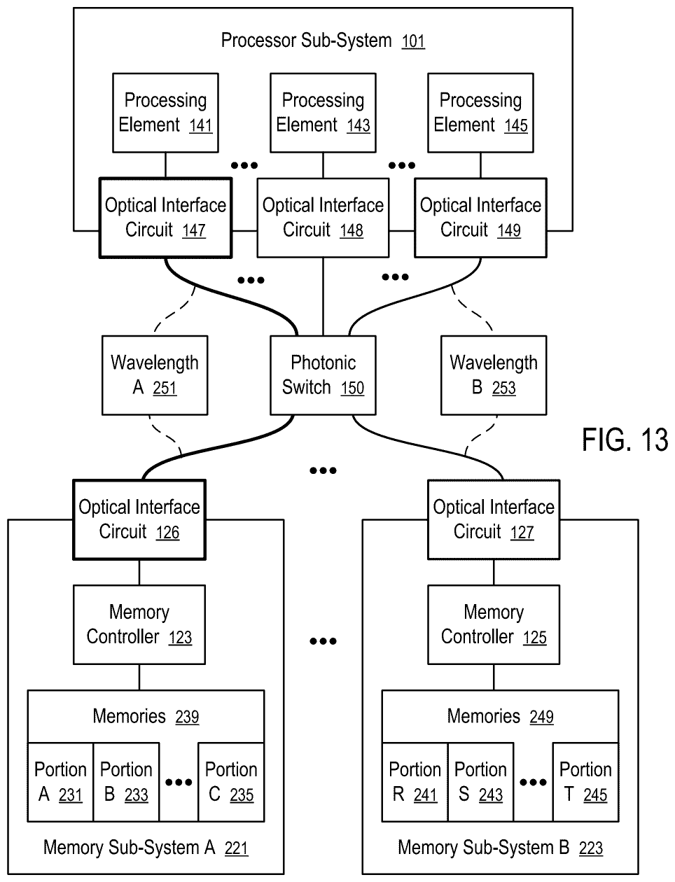

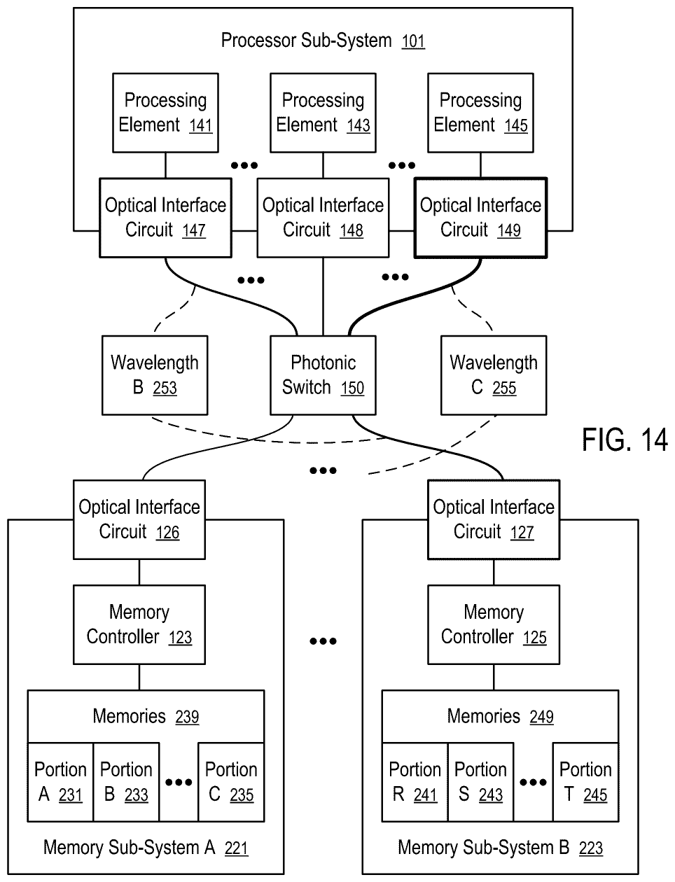

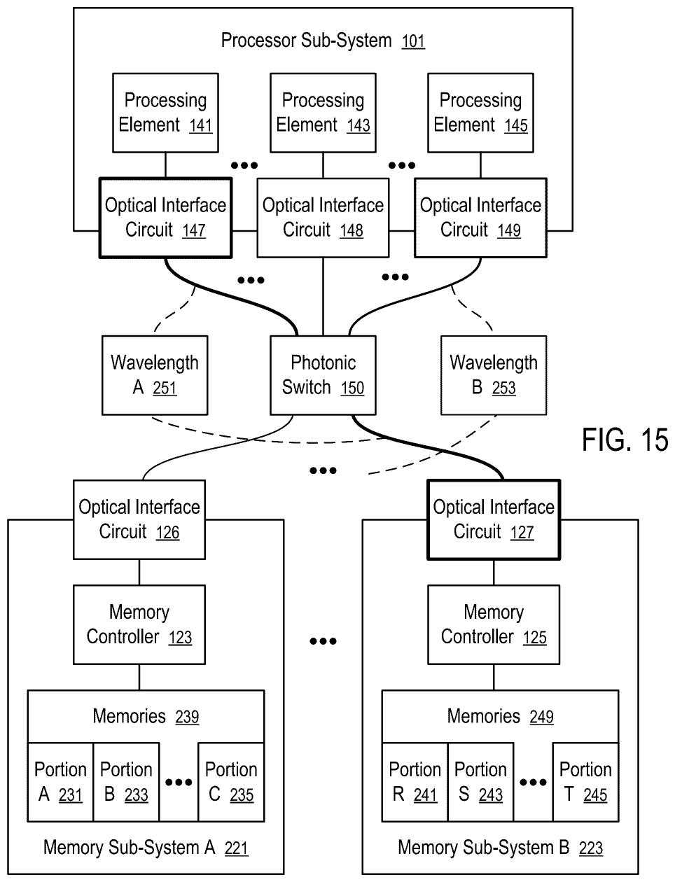

Optionally, the optical interface circuits 147, . . . , 148, . . . , 149, 126, . . . , 127 and the photonic switch 150 can be configured to use different channels of optical signals of different wavelengths for the communications between the processing elements 141, . . . , 143, . . . , 145 and respective portions in their allocated slices, as further illustrated in FIG. 13, FIG. 14 and FIG. 15.

FIG. 11 shows the use of photonic interconnects, implemented using optical interface circuits (e.g., 147, 126) connected with a photonic switch 150, to connect processing elements to the memories allocated from the memory sub-system 221, . . . , 223. Alternatively, electrical interfaces with a network of wired connections to a switch can be used to provide such interconnections.

FIG. 12 shows the mapping between a virtual memory space addressed by a processing element and portions of memories allocated from a plurality of memory sub-systems according to one embodiment.

For example, the access by a processing element 141 in FIG. 11 to a splice of memories allocated from a plurality of memory sub-systems 221, . . . , 223 as connected in the computing system of FIG. 11 can be managed using the technique of FIG. 12.

In FIG. 12, the processing element 141 can run an application 269 to generate memory access requests (e.g., 261). A typical memory access request (e.g., 261) from the processing element 141 can have a memory address 263 in a memory space 267 to be mapped to a slice of the memories 239, . . . 249 allocated across the plurality of memory sub-systems 221, . . . , 223.

In one implementation, the memory address 263 is usable directly in any of the memory sub-systems 221, . . . , 223. Each of the memory sub-systems 221, . . . , 223 has a memory location represented by the same memory address 263; and the photonic switch 150 is used to route the access request 261 to one of the memory sub-system 221 that contains the corresponding memory location that is currently being allocated to the processing element 141.

For example, based on the current memory demand of the application 269 running in the processing element 141, portions 231, . . . , 245 are allocated from the memory sub-systems 221, . . . , 223 to form a slice of allocated memories 265 of the processing element 141.

Since the memory address 263 as specified in the access request 261 is to be used directly in the memory sub-systems 221, . . . , 223, the portions (e.g., 231, . . . , 245) in the allocated memories 265 are allocated to have different, non-overlapping memory addresses in their respective memory sub-systems 221, . . . , 223.

For example, memory addresses used in the memory sub-system 221 to access a portion 231 allocated from the memory sub-system 221 for the processing element 141 do not overlap with memory addresses used in another memory sub-system (e.g., 223) to access another portion (e.g., 245) allocated to the processing element 141.

Thus, based on the memory address 263, the memory manager implemented via the photonic interconnect system (e.g., optical interface circuits 147, . . . , 148, . . . , 149, . . . , 126, . . . , 127 as connected via the photonic switch 150) can identify a portion (e.g., 231) that contains the memory address 263. Thus, the photonic interconnect system can route the access request 261 to the memory sub-system (e.g., 221) containing the portion (e.g., 231) being allocated to the processing element 141 and being addressed by the access request 261. In response, the photonic interconnect system provides a virtual communication channel between the memory sub-system 221 and the processing element 141 to facilitate the memory access according to the request 261.

In such an implementation, the memory space 267 usable by the application 269 is the union of the physical memory addresses of the portions 231, . . . , 245 in the allocated memories 265 as in their respective memory sub-system 221, . . . , 223. Optionally, the memory space 267 is not continuous (e.g., when none of the allocated memories 265 uses addresses that are same as the physical addresses of the portion 233 in the memory sub-system 221).

In another implementation, the memory space 267 is a contiguous virtual memory address space used by the processing element 141. The photonic interconnect system is configured to map the addresses from the memory space 267 into the physical addresses in the portions 231, . . . , 245 of the allocated memories 265 from the memory sub-systems 221, . . . , 223. After identifying a portion (e.g., 231) being using to implement the memory address 263 in the memory space 267, the photonic interconnect system can determine the corresponding physical address in the portion 231 used to implement the memory address 263 in the memory space 267, and replace the memory address 263 with the physical address in the portion (e.g., 231) in routing the access request 261 to the memory sub-system (e.g., 221) that contains the portion (e.g., 231).

In some implementations, the virtual communication channels configured by the photonic interconnect system between the processing element 141 and a memory sub-system (e.g., 221) being addressed by the access request 261 is based on an optical signal wavelength assigned to the optical interface circuit 147 of the processing element 141 in processing the access request 261, as in FIG. 13, FIG. 14, and FIG. 15.

FIG. 13, FIG. 14, and FIG. 15 illustrate examples of photonic channels configured to manage memory accesses by processing elements according to one embodiment.

For example, the connection from a processing element 141 to a memory sub-system (e.g., 221) being accessed by a memory access request 261 from the processing element 141 in FIG. 12 can be provided by using techniques of FIG. 13, FIG. 14, and FIG. 15.

In FIG. 13, a processing element 141 can provide an access request (e.g., 261) to its connected optical interface circuit 147 in the processor sub-system 101. In response, a virtual communication channel represented by optical signals of a particular wavelength 251 propagating in the photonic interconnect system can be assigned to the optical interface 147 of the processing element 141 and the optical interface (e.g., 126) of a memory sub-system (e.g., 221) being addressed by the access request (e.g., 261).

For example, the photonic interconnection system can determine (e.g., as in FIG. 11) that the access request 261 from the processing element 141 is addressed to a memory portion 231 allocated from the memory sub-system 221 to the processing element 141. In response, the photonic interconnection system can be configured to instruct the optical interface circuit 147 to transmit, using the wavelength 251 of optical signals routed by the photonic switch 150 to the optical interface circuit 126. As a result, the transmission of the access request 261 by the optical interface circuit 147 is routed through the photonic switch 150 to the optical interface circuit 126 of the memory sub-system 221, but not to other memory sub-systems (e.g., 223).

For example, when the memory sub-system 221 is to transmit response data back to the processing element 141 in response to the access request 261, the photonic interconnection system can be configured to instruct the optical interface circuit 126 of the memory sub-system 221 to transmit, using the wavelength 251 of optical signals routed by the photonic switch 150 to the optical interface circuit 147 of the processing element 141. As a result, the transmission of the response data by the optical interface circuit 127 of the memory sub-system 221 is routed through the photonic switch 150 to the optical interface circuit 147 of the processing element 141, but not to other processing elements (e.g., 143 or 145).

Concurrently with the processing element 141 accessing the memory sub-system 221, another processing element (e.g., 145) can access another memory sub-system (e.g., 223) using optical signals of another wavelength (e.g., 253).

Thus, different wavelengths (e.g., 251, 253) of optical signals can be used concurrently by different processing elements (e.g., 141, 145) to access the memory sub-systems 221, . . . , 223.

Optionally, an optical interface circuit (e.g., 126) of a memory sub-system (e.g., 221) can be assigned multiple wavelengths for concurrent operations (e.g., transmission or reception) to service concurrent access requests from one or more processing elements in the processor sub-system 101.

Similarly, an optical interface circuit (e.g., 147) of a processing element (e.g., 141) can be assigned multiple wavelengths for concurrent operations (e.g., transmission or reception) to make concurrent access requests addressed to one or more memory sub-systems 221, . . . , 223.

In general, a same wavelength is not used concurrently by multiple optical interfaces of different processing elements; and a same wavelength is not used concurrently by multiple optical interface circuits of different memory sub-systems. Thus, a pair of optical interface circuits, one connected to a processing element and the other to a memory sub-system, can be configured to use a same wavelength to form a virtual communication channel, represented by the wavelength, through the optical interconnect system.

The wavelengths assigned to the optical interfaces can change, depending on the access requests.

For example, in FIG. 14, when the processing element 141 sends to its optical interface circuit 147 an access request that addresses a portion (e.g., 245) in the memory sub-system 223, the optical interface circuit 147 of the processing element 141 and the optical interface circuit 127 of the memory sub-system 223 can be instructed to use a same wavelength 253 and thus a virtual communication channel represented by the wavelength 253 through the photonic switch 150.

Similarly, the optical interface circuit 149 of the processing element 145 can be instructed to use a virtual communication channel of wavelength 255 connected to a memory sub-system (e.g., 221, or 223).

Optionally, the wavelength of the virtual communication channel configured between a processing element (e.g., 141) and a memory sub-system (e.g., 223) can change.

For example, during a period of time, a virtual communication channel of a wavelength 253 is configured between the processing element 141 and the memory sub-system 223 as in FIG. 14. During another period of time, a virtual communication channel of a wavelength 251 is configured between the processing element 141 and the memory sub-system 223, as in FIG. 15; and the virtual communication channel of the wavelength 253 can be configured between another processing element 145 and another memory sub-system, as in FIG. 15.

Optionally, during a further period of time, both virtual communication channels of wavelengths 251 and 253 are configured between the processing element 141 and the memory sub-system 223.

Optionally, the optical interface circuits 147, . . . , 148, . . . , 149 of the processor sub-system 101 can be replaced with an optical interface module (e.g., 128) having one or more optical transmitters 151 configured as in FIG. 4. Separate buffers 158 of the optical interface module 128 can be configured for the processing elements 141, . . . , 143, . . . , 145 respectively to buffer the access requests (e.g., 261) from the respective processing elements 141, . . . , 143, . . . , 145. The controller 155 of the optical interface module 128 can selectively use the microring resonators 163 of wavelengths assigned to the optical receivers 153 of the memory sub-system 221 to cause the transmissions to be routed into the optical receivers 153 of the memory sub-system 221.

Optionally, the photonic switch 150 can be replaced with an optical fiber (e.g., 194 or 196), when the optical receivers 153 (or microring resonators 171, . . . , 173) of the different memory sub-systems 221, . . . , 223 are configured, or instructed, to receive using different wavelengths.

Optionally, the photonic switch 150 can include an optical demultiplexer (e.g., implemented using arrayed waveguide grating (AWG)) configured to separate optical signals of different wavelengths into different optical paths connected to the optical interface circuits 126, . . . , 127 of the memory sub-systems 221, . . . , 223. When each optical path is configured to receive optical signals of a predetermined wavelength, a photodetector 172 can be used without using the microring resonators (e.g., 171, or 173) in the optical receivers 153.

Similarly, transmission can be configured to operate using separate light sources of different wavelengths; and the photonic switch 150 can include an optical multiplexer (e.g., implemented using waveguide grating (AWG)) configured to combine optical signals of different wavelengths into a single optical path (e.g., for propagation over an optical fiber (e.g., 194 or 196) in the optical interconnect system).

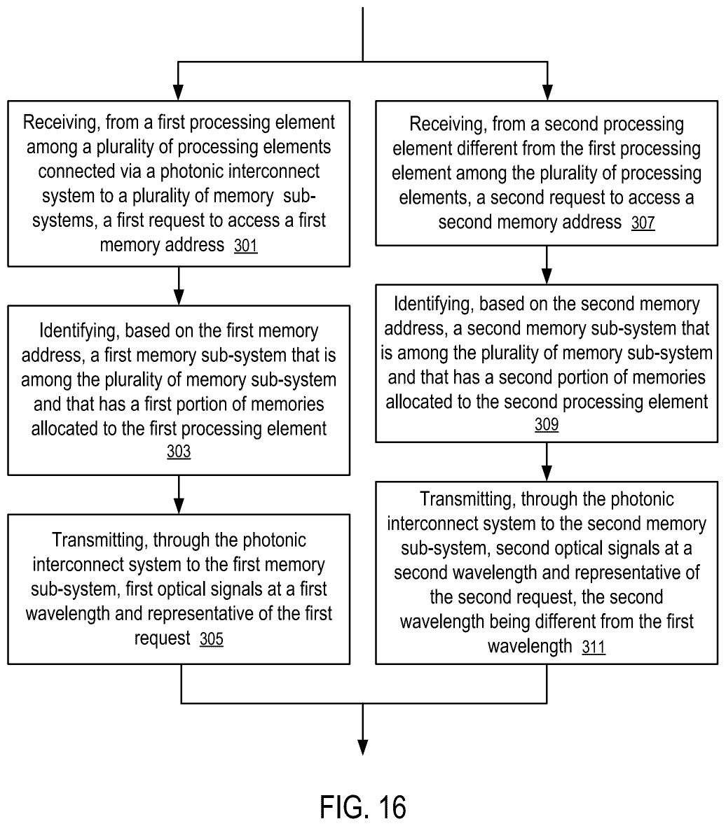

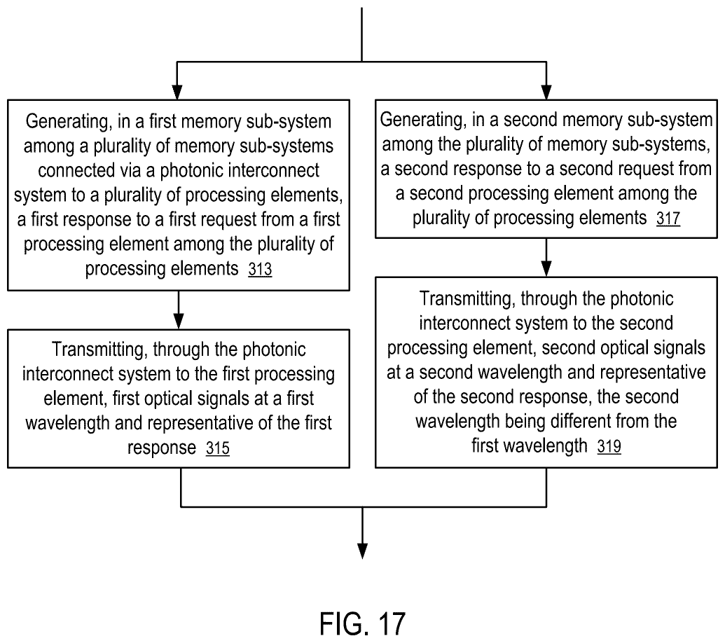

FIG. 16 and FIG. 17 show methods of memory access management according to some embodiments.

For example, the methods of FIG. 16 and FIG. 17 can be implemented in a computing system of FIG. 11 with an optical interconnect system having optical interface circuits 147, . . . , 148, . . . , 149, 126, . . . , 127 connected to provide dynamic, wavelength based, virtual channels between processing elements 141, . . . , 143, . . . , 145 and memory sub-systems 221, . . . , 223. The optical interconnect system can implement the memory mapping techniques of FIG. 12, and virtual channel techniques of FIG. 13, FIG. 14, and FIG. 15. For example, the optical transmitters 151, receivers 153, and transceivers 176 can be implemented as in FIG. 4. Alternatively, generation of transmitted optical signals of different wavelengths can be on separate waveguides for combination via an optical multiplexer of a photonic switch 150 onto a single optical fiber; and detection of receive optical signals of different wavelengths can be on separate waveguides connected to an optical demultiplexer of the photonic switch 150 from the single optical fiber. Optionally, the systolic access pattern as in FIG. 1 can be used.

For example, the computing system can include a plurality of memory sub-systems 221, . . . , 223; a plurality of processing elements 141, . . . , 143, . . . , 145; and a photonic interconnect system coupled between the plurality of memory sub-systems 221, . . . , 223 and the plurality of processing elements 141, . . . , 143, 145. The photonic interconnect system can include a plurality of first optical interface modules (e.g., containing optical interface circuits 147, . . . , 148, . . . , 149 respectively) connected to the plurality of processing elements 141, . . . , 143, . . . , 145 respectively. The photonic interconnect system can further include a plurality of second optical interface modules (e.g., containing optical interface circuits 126, . . . , 127 respectively) connected to the plurality of memory sub-systems 221, . . . , 223 respectively. The photonic interconnect system can include a photonic switch 150 configured between the plurality of first optical interface modules and the plurality of second optical interface modules.

For example, the photonic interconnect system can be configured to dynamically allocate virtual communication channels between the plurality of processing elements and the plurality of memory sub-systems. The virtual communication channels can be implemented via optical signals of different wavelengths (e.g., 251, . . . , 253) routed in the photonic interconnect system.

For example, the photonic switch 150 can include at least an optical demultiplexer, or an optical multiplexer, or both. For example, the photonic switch 150 can include an arrayed waveguide grating (AWG) to direct the propagation of optical signals of different wavelengths on different paths between the processing elements 141, . . . , 143, . . . , 145 and the memory sub-systems 221, . . . , 223.

At block 301 in FIG. 16, a method of memory access management includes receiving, from a first processing element (e.g., 141) among a plurality of processing elements 141, . . . , 143, . . . , 145 connected via a photonic interconnect system to a plurality of memory sub-systems 221, . . . , 223, a first request to access a first memory address.

At block 303, the method includes identifying, based on the first memory address, a first memory sub-system (e.g., 221) that is among the plurality of memory sub-system 221, . . . , 223 and that has a first portion (e.g., 231) of memories 239 allocated to the first processing element (e.g., 141).

For example, the same first memory address can be used to address a memory location in a corresponding portion (e.g., 231, . . . , 241) in each of the plurality of memory sub-systems 221, . . . , 223. However, only one of the memory sub-systems 221, . . . , 223 contains such a portion (e.g., 231) that is currently allocated to the first processing element (e.g., 141), the first processing element (e.g., 141) can be identified.

Optionally, the first memory address is a virtual memory address that is mapped to a portion (e.g., 231) in the first memory sub-system 221. Thus, based on the currently memory allocation and mapping scheme, the first memory sub-system 221 as the target of the first request can be identified.

To facilitate the communication between the first processing element (e.g., 141) and the first memory sub-system (e.g., 221), a virtual communication channel corresponding to a wavelength of optical signals routed in the photonic interconnect system can be allocated from the transmission of the first request from the first processing element (e.g., 141) to the first memory sub-system (e.g., 221), while allowing other processing elements to communicate their memory access requests concurrently using the photonic interconnect system using other wavelengths, as in block 307 to block 311.

At block 305, the method includes transmitting, through the photonic interconnect system to the first memory sub-system (e.g., 221), first optical signals that are at a first wavelength (e.g., 251) and that are representative of the first request.

In parallel with block 301 to block 305, another processing element (e.g., 145) can use the photonic interconnect system to access the memory sub-systems 221, . . . , 223 concurrently, as in block 307 to block 311, using a different wavelength (e.g., 253).

At block 307, the method includes receiving, from a second processing element (e.g., 145) different from the first processing element (e.g., 141) among the plurality of processing elements 141, 143, . . . , 145, a second request to access a second memory address.

At block 309, the method includes identifying, based on the second memory address, a second memory sub-system (e.g., 221, or 223) that is among the plurality of memory sub-system 221, . . . , 223 and that has a second portion (e.g., 235, or 245) of memories (e.g., 239 or 249) allocated to the second processing element (e.g., 145).

In some instances, the first memory sub-system and the second memory sub-system are a same memory sub-sub-system (e.g., 221) in the plurality of memory sub-systems 221, . . . , 223; and the first portion (e.g., 231) of memories 239 allocated to the first processing element 141 is different from the second portion (e.g., 235) of memories 239 allocated to the second processing element 145.

For example, the photonic interconnect system can concurrently connect multiple virtual channels, implemented using optical signals of different wavelengths (e.g., 251 and 253), from different processing elements (e.g., 141 and 145) to a same memory sub-system (e.g., 221).

In other instances, the first memory sub-system (e.g., 221) is different from the second memory sub-system (e.g., 223) in the plurality of memory sub-systems 221, . . . , 223. The first memory address and the second memory address can be the same (or different) but allocated from different memory sub-systems (e.g., 221 and 223); and the photonic interconnect system can concurrently connect different virtual channels, implemented using optical signals of different wavelengths (e.g., 251 and 253), from the different processing elements (e.g., 141 and 145) to the respective memory sub-systems (e.g., 221 and 223) being accessed.

At block 311, the method includes transmitting, concurrently with transmission of the first request and through the photonic interconnect system to the second memory sub-system (e.g., 223), second optical signals that are at a second wavelength (e.g., 253) and representative of the second request. The second wavelength (e.g., 253) is different from the first wavelength (e.g., 251).

For example, the photonic interconnect system is configured to propagate the first optical signals to a first photonic receiver (e.g., in the optical interface circuit 126) connected to the first memory sub-system (e.g., 221) but not to a second photonic receiver (e.g., in the optical interface circuit 127) connected to the second memory sub-system (e.g., 223); and the photonic interconnect system is configured to propagate the second optical signals to the second photonic receiver connected to the second memory sub-system (e.g., 223) but not to the first photonic receiver connected to the first memory sub-system (e.g., 221).

For example, the method can further include: separating, via an optical demultiplexer (e.g., in photonic switch 150), the first optical signals and the second optical signals from an optical fiber onto separate paths toward the first photonic receiver (e.g., in optical interface circuit 126) and the second photonic receiver (e.g., in optical interface circuit 127) respectively.

For example, the photonic switch 150 can route optical signals in a first wavelength region to the optical interface circuit 126 of the first memory sub-system 221, and route optical signals in a second wavelength region to the optical interface circuit 127 of the second memory sub-system 223. The first wavelength region and the second wavelength region can be separate and have no overlapping portion. Alternatively, the first wavelength region and the second wavelength region can have an overlapping portion; and the photonic interconnect system can be configured to prevent the simultaneous use of the overlapping portion for communications with the different memory sub-system 221 and 223.

Optionally, the method can further include: propagating, via an optical multiplexer (e.g., in photonic switch 150) and onto the optical fiber, the first optical signals from a first photonic transmitter (e.g., in optical interface circuit 147) connected to the first processing element 141 and the second optical signal from a second photonic transmitter (e.g., in optical interface circuit 149) connected to the second processing element 145.

Optionally, the method can further include: instructing a first photonic receiver (e.g., in the optical interface circuit 126) connected to the first memory sub-system 221 to operate at the first wavelength 251 during the transmission of the first request; and instructing a second photonic receiver (e.g., in the optical interface circuit 127) connected to the second memory sub-system 223 to operate at the second wavelength 253 during transmission of the second request.

Optionally, the method can further include: instructing a first photonic transmitter (e.g., in the optical interface circuit 147) connected to the first processing element 141 to operate at the first wavelength during the transmission of the first request; and instructing a second photonic transmitter (e.g., in the optical interface circuit 149) connected to the second processing element 145 to operate at the second wavelength during the transmission of the second request.

For example, the optical transmitters (e.g., 151) and/or the optical receivers (e.g., 153) can be configured to be capable of operating at different wavelengths. The operating wavelengths of the optical transmitters (e.g., 151) and/or the optical receivers (e.g., 153) can be adjusted to implement the virtual communication channels for different combinations of access requesters (e.g., processing elements 141 and 145) and access request recipients (e.g., memory sub-systems 221 and 223). In some implementations, the photonic switch 150 can be omitted when the virtual communication channels are configured via the configuration of operating wavelengths of the optical transmitters (e.g., 151) and/or the optical receivers (e.g., 153) in the optical interface circuits 147, . . . , 148, . . . , 149, 126, . . . , 127.

The method of FIG. 16 can be used to communicate access requests from the processing elements 141, . . . , 143, . . . , 145 to the memory sub-systems 221, . . . , 223. The method of FIG. 17 can be used to communicate responses to the access requests to the processing elements 141, . . . , 143, . . . , 145 from the memory sub-systems 221, . . . , 223.

Optionally, the photonic interconnect system can connect concurrently multiple virtual channels of different wavelengths from a same processing element (e.g., 141) to different memory sub-systems (e.g., 221, 223) for the transmission of multiple memory requests in parallel.

At block 313 of FIG. 17, the method of memory access management includes generating, in a first memory sub-system (e.g., 221) among a plurality of memory sub-systems 221, . . . , 223 connected via a photonic interconnect system to a plurality of processing elements 141, . . . , 143, . . . , 145, a first response to a first request (e.g., as received in block 305) from a first processing element (e.g., 141) among the plurality of processing elements 143, . . . , 145.

At block 315, the method includes transmitting, through the photonic interconnect system to the first processing element 141, first optical signals that are at a first wavelength 251 and that are representative of the first response.

For example, the transmission of the first response in block 315 can be configured to be performed after a predetermined time interval after the transmission of the first request in block 305. The photonic interconnect system can be configured to use the same virtual channel allocation for the transmission of the requests (e.g., at blocks 305 and 311) to facilitate the transmission of responses.

Alternatively, the transmission of the first request in block 315 can include the identification of the first processing element 141 as the requester; and the first memory sub-system 221 can identify the recipient of the first response in requesting the transmission of the first response.

Alternatively, the first memory sub-system 221 can be identified as the recipient of the first response based on the first memory address of the first request, and the scheme of memory allocation and/or virtual memory mapping.

In parallel with block 313 to block 315, another response can be transmitted over the photonic interconnect system using a different wavelength (e.g., 253 or 255), as in block 317 to block 319.

At block 317, the method includes generating, in a second memory sub-system (e.g., 221 or 223) among the plurality of memory sub-systems 221, . . . , 223, a second response to a second request (e.g., received in block 311) from a second processing element 145 among the plurality of processing elements 141, . . . , 143, . . . , 145.

At block 319, the method includes transmitting, concurrently with transmission of the first response and through the photonic interconnect system to the second processing element 145, second optical signals that are at a second wavelength 253 and that are representative of the second response. The second wavelength 253 is different from the first wavelength 251.

For example, the first memory sub-system and the second memory sub-system can be a same memory sub-sub-system 221 in the plurality of memory sub-systems 221, . . . 223 in some instances. In other instances, the first memory sub-system 221 is different from the second memory sub-system 223 in the plurality of memory sub-systems 221, . . . , 223. In further instances, the first processing element and the second processing element are a same processing element 141 in the plurality of processing elements 141, . . . , 143, . . . , 145, while the first memory sub-system 221 is different from the second memory sub-system 223.

Similarly to the transmission of the first request and the second requests, the photonic interconnect system can be configured to propagate the first optical signals to a first photonic receiver (e.g., in the optical interface circuit 147) connected to the first processing element 141 but not to a second photonic receiver (e.g., in the optical interface circuit 149) connected to the second processing element 145; and the photonic interconnect system is configured to propagate the second optical signals to the second photonic receiver connected to the second processing element 145 but not to the first photonic receiver connected to the first processing element 141.

For example, the method can further include: separating, via an optical demultiplexer (e.g., in photonic switch 150), the first optical signals and the second optical signals from an optical fiber onto separate paths toward the first photonic receiver (e.g., in the optical interface circuit 147) and the second photonic receiver (e.g., in the optical interface circuit 149) respectively. Optionally, the method can further include: propagating, via an optical multiplexer (e.g., in photonic switch 150) onto the optical fiber, the first optical signals from a first photonic transmitter (e.g., in the optical interface circuit 126) connected to the first memory sub-system 221 and the second optical signal from a second photonic transmitter (e.g., in the optical interface circuit 127) connected to the second memory sub-system 223.

In some implementations, the optical interface circuits 147, . . . , 148, . . . , 149, 126, . . . , 127 of the photonic interconnect system can each operate at multiple wavelengths; and the wavelength capabilities of the optical interface circuits 147, . . . , 148, . . . , 149 of the processing elements can overlap or the same; and the wavelength capabilities of the optical interface circuits 126, . . . , 127 of the memory sub-systems 221, . . . 223 can overlap or the same. To allocate virtual channels between the senders of the responses and the corresponding recipients of the responses, the photonic interconnect system can instruct the optical interface circuits 147, . . . , 148, . . . , 149, 126, . . . , 127 to use selected wavelengths.

For example, the method can further include: instructing a first photonic receiver (e.g., in optical interface circuit 147) connected to the first processing element 141 to operate at the first wavelength 251 during the transmission of the first response; instructing a second photonic receiver (e.g., in optical interface circuit 149) connected to the second processing element 145 to operate at the second wavelength 253 during transmission of the second response; instructing a first photonic transmitter (e.g., in the optical interface circuit 126) connected to the first memory sub-system 221 to operate at the first wavelength 251 during the transmission of the first response; and instructing a second photonic transmitter (e.g., in the optical interface circuit 127) connected to the second memory sub-system 223 to operate at the second wavelength 253 during transmission of the second response.

In general, a memory sub-system can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The memory sub-system can be installed in a computing system to accelerate multiplication and accumulation applied to data stored in the memory sub-system. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems. In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCle) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of the firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A computing system, comprising:
a plurality of memory sub-systems;
a plurality of processing elements; and
a photonic interconnect system having:
a plurality of first optical interface modules connected to the plurality of processing elements respectively;
a plurality of second optical interface modules connected to the plurality of memory sub-systems respectively; and
a photonic switch configured between the plurality of first optical interface modules and the plurality of second optical interface modules.

2. The computing system of claim 1, wherein the photonic interconnect system is configured to dynamically allocate virtual communication channels, implemented via optical signals of different wavelengths in the photonic interconnect system, between the plurality of processing elements and the plurality of memory sub-systems.

3. The computing system of claim 2, wherein the photonic switch includes at least an optical demultiplexer or an optical multiplexer.

4. The computing system of claim 2, wherein the photonic switch includes an arrayed waveguide grating (AWG).

5. A method, comprising:
receiving, from a first processing element among a plurality of processing elements connected via a photonic interconnect system to a plurality of memory sub-systems, a first request to access a first memory address;
identifying, based on the first memory address, a first memory sub-system that is among the plurality of memory sub-system and that has a first portion of memories allocated to the first processing element;
transmitting, through the photonic interconnect system to the first memory sub-system, first optical signals at a first wavelength and representative of the first request;
receiving, from a second processing element different from the first processing element among the plurality of processing elements, a second request to access a second memory address;
identifying, based on the second memory address, a second memory sub-system that is among the plurality of memory sub-system and that has a second portion of memories allocated to the second processing element; and
transmitting, concurrently with transmission of the first request and through the photonic interconnect system to the second memory sub-system, second optical signals at a second wavelength and representative of the second request, the second wavelength being different from the first wavelength.

6. The method of claim 5, wherein the first memory sub-system and the second memory sub-system are a same memory sub-sub-system in the plurality of memory sub-systems; and the first portion of memories allocated to the first processing element is different from the second portion of memories allocated to the second processing element.

7. The method of claim 5, wherein the first memory sub-system is different from the second memory sub-system in the plurality of memory sub-systems.

8. The method of claim 7, wherein the photonic interconnect system is configured to propagate the first optical signals to a first photonic receiver connected to the first memory sub-system but not to a second photonic receiver connected to the second memory sub-system; and the photonic interconnect system is configured to propagate the second optical signals to the second photonic receiver connected to the second memory sub-system but not to the first photonic receiver connected to the first memory sub-system.

9. The method of claim 8, further comprising:
separating, via an optical demultiplexer, the first optical signals and the second optical signals from an optical fiber onto separate paths toward the first photonic receiver and the second photonic receiver respectively.

10. The method of claim 9, further comprising:
propagating, via an optical multiplexer and onto the optical fiber, the first optical signals from a first photonic transmitter connected to the first processing element and the second optical signal from a second photonic transmitter connected to the second processing element.

11. The method of claim 7, further comprising:
instructing a first photonic receiver connected to the first memory sub-system to operate at the first wavelength during the transmission of the first request; and
instructing a second photonic receiver connected to the second memory sub-system to operate at the second wavelength during transmission of the second request.

12. The method of claim 11, further comprising:
instructing a first photonic transmitter connected to the first processing element to operate at the first wavelength during the transmission of the first request; and
instructing a second photonic transmitter connected to the second processing element to operate at the second wavelength during the transmission of the second request.

13. A method, comprising:
generating, in a first memory sub-system among a plurality of memory sub-systems connected via a photonic interconnect system to a plurality of processing elements, a first response to a first request from a first processing element among the plurality of processing elements;
transmitting, through the photonic interconnect system to the first processing element, first optical signals at a first wavelength and representative of the first response;
generating, in a second memory sub-system among the plurality of memory sub-systems, a second response to a second request from a second processing element among the plurality of processing elements; and
transmitting, concurrently with transmission of the first response and through the photonic interconnect system to the second processing element, second optical signals at a second wavelength and representative of the second response, the second wavelength being different from the first wavelength.

14. The method of claim 13, wherein the first memory sub-system and the second memory sub-system are a same memory sub-sub-system in the plurality of memory sub-systems.

15. The method of claim 13, wherein the first memory sub-system is different from the second memory sub-system in the plurality of memory sub-systems.

16. The method of claim 15, wherein the photonic interconnect system is configured to propagate the first optical signals to a first photonic receiver connected to the first processing element but not to a second photonic receiver connected to the second processing element; and the photonic interconnect system is configured to propagate the second optical signals to the second photonic receiver connected to the second processing element but not to the first photonic receiver connected to the first processing element.

17. The method of claim 16, further comprising:
separating, via an optical demultiplexer, the first optical signals and the second optical signals from an optical fiber onto separate paths toward the first photonic receiver and the second photonic receiver respectively.

18. The method of claim 17, further comprising:
propagating, via an optical multiplexer and onto the optical fiber, the first optical signals from a first photonic transmitter connected to the first memory sub-system and the second optical signal from a second photonic transmitter connected to the second memory sub-system.

19. The method of claim 15, further comprising:
instructing a first photonic receiver connected to the first processing element to operate at the first wavelength during the transmission of the first response; and
instructing a second photonic receiver connected to the second processing element to operate at the second wavelength during transmission of the second response.

20. The method of claim 19, further comprising:
instructing a first photonic transmitter connected to the first memory sub-system to operate at the first wavelength during the transmission of the first response; and
instructing a second photonic transmitter connected to the second memory sub-system to operate at the second wavelength during transmission of the second response.
